(19) United States
(12) Patent Application Publication
(10) Pub. No.: US 2012/0255345 A1
(43) Pub. Date: Oct. 11, 2012

(54) METHODS AND SYSTEMS FOR DETECTING AND SEALING DRY FIT CONNECTIONS IN A PIPING ASSEMBLY

(75) Inventors: James E. Golinveaux, N. Kingstown, RI (US); Carmine L. Schiavone, Schwenksville, PA (US); John A. Amarello, Fairhaven, MA (US)

(73) Assignee: TYCO FIRE JPRODUCTS LP, LANSDALE, PA (US)

(21) Appl. No.: 12/443,678

(22) PCT Filed: Jan. 10, 2008
(86) PCT No.: PCT/US08/50821

§ 371 Date: Jun. 21, 2012

Related U.S. Application Data
(60) Provisional application No. 60/884,262, filed on Jan. 10, 2007.
(60) Provisional application No. 60/917,459, filed on May 11, 2007.
(60) Provisional application No. 60/956,655, filed on Aug. 17, 2007.
(60) Provisional application No. 60/977,010, filed on Oct. 2, 2007.

(51) Int. Cl. G01M 3/08

(52) U.S. Cl. 73/49.1

(57) ABSTRACT

Systems and methods for evaluating a piping system for an improperly assembled fluid tight connection. Provided is a preferred joint assembly unable to hold fluid pressure in either one of a dry fit connection and partial seal connection. The joint assembly includes a coupler to identify a leak. More specifically, the coupler includes a substantially tubular wall portion having an outer surface, an inner surface and a channel disposed along one of the inner and outer surfaces. The channel has a first configuration for carrying a fluid between an interior of the piping system and an exterior of a piping system, and a second configuration to prevent fluid from being carried between the interior and the exterior of the piping system. The channel is further preferably convertible from the first configuration to the second configuration in the presence of a minimum amount of sealant material.

### PRIORITY DATA & INCORPORATION BY REFERENCE

This is a National Stage application under 35 U.S.C. 371 of International Application No. PCT/US2008/050821, filed Jan. 10, 2008 which claims the benefit of priority to (i) U.S. Provisional Patent Application No. 60/977,010 filed Oct. 2, 2007; (ii) U.S. Provisional Patent Application No. 60/956,655 filed Aug. 17, 2007; (iii) U.S. Provisional Patent Application No. 60/917,459 filed May 11, 2007; and (iv) U.S. Provisional Patent Application No. 60/884,262 filed Jan. 10, 2007, each of which is incorporated by reference in its entirety.

### TECHNICAL FIELD

The present invention relates to methods and systems for verifying and ensuring the integrity of a piping system that uses a sealant material in its joint assemblies to form fluid tight sealed joint connections or assemblies. More specifically, the methods and systems are provided for detecting a joint connection in the system without a sealant material (a dry fit connection), or a joint connection in the system with an insufficient amount of sealant material, each of which define an improperly sealed joint connection. In addition, the methods and systems herein provide means for identifying the location of an improperly sealed joint connection. Included are products for forming the joint assemblies; these products further form a detectable leak path in an improperly sealed joint connection through which fluid can be exchanged between the interior of the joint connection and the exterior of the joint connection.

### BACKGROUND ART

There are a variety of piping system applications in which maintaining a fluid-tight seal at the various piping connections and junctures are believed to be of critical importance to the operation and maintenance of the piping system. Some piping systems use a chemical weld in a socket-type connection between piping elements to form a joint assembly. In a socket-type connection, tight tolerances between piping elements tend to form an interference or “dry fit” between interfacing surfaces. To form a fluid-tight sealed and permanent joint connection, a sealant material or solvent cement is applied to the components to seal their connection by way of, for example, a chemical weld, material melding, bond or other interconnection. Failure to apply any sealant material, or at least an adequate amount of sealant material, can render the dry fit joint connections or assemblies of the system susceptible to leakage. However, the dry fit formation between the engaged surfaces of the pipe element can mask an improper seal in the joint connection, and the assembly can at least temporarily hold fluid pressure. This can create a problem because pressure surges, the passage of time, and/or vibration can cause these dry fit connections or connections without an appropriate amount of sealant material (partial seals) to fail.

Even minor leaks from improperly sealed joint connections or assemblies can cause damage to the surrounding property or environment. For example, in a fire protection system and, more specifically, a residential fire protection system, joint assemblies are formed by chemical welding a socket-type connection between piping elements such as, for example, a pipe end inserted into a pipe coupling socket, each of which is made from a plastic such as Post Chlorinated Polyvinyl Chloride (CPVC). If a dry fit/partial seal connection in such a system is improperly sealed, goes undetected, and is placed into service, property damage and in particular personal property damage can result should the dry fit/partial seal connection fail.

As a matter of practice, a fire protection piping contractor or installer initially assembles the pipe elements to check the dry fit/partial seal, disassembles the connection, applies the sealant about the outer surface of the pipe and the inner surface of the socket, rejoins the elements and allows the sealant to cure. In a residential application of 1,000 square feet, 75-100 socket type connections may be present each requiring application of the sealant material. Due to the large number of fittings present and/or human error, some connections do not receive any sealant or at least a sufficient amount of sealant. Accordingly, it is desirable to perform a static fluid or leak test upon the piping system before placing the system in service. If the system holds fluid pressure, the system is placed into service and the construction of the residence is completed. However, as noted above, in the absence a sealant material or an adequate amount of sealant, a joint connection can pass the leak test due to the dry fit/partial seal between the piping elements which can give a false passing result in the leak test.

Moreover, pneumatic or hydrostatic testing of a pipe joint connection can present a hazard to installers or other contracting personnel. In some instances, a dry fit connection can form a dry fit capable of holding liquid or gas which can result in the build up of pressure within a segment of the piping system around the joint. During pneumatic or hydrostatic testing, a dry fit joint connection may eventually reach a threshold pressure and fail. The sudden release of internal pressure and its potential energy may be sufficient to propel, for example, an end cap or other pipe segment away from the pipe end; thereby making the pipe fitting a projectile capable of causing property damage and/or personal injury.

### SUMMARY OF THE INVENTION

The present invention provides methods and systems for the assembly, construction and testing of piping systems that incorporates a joint connection or assembly capable of indicating an improper seal. Preferably, the joint assembly is configured for piping systems that employ socket-type fittings with a flowable sealant material to seal the joint assembly. In particular, the preferred joint assembly is unable to hold fluid pressure if the joint assembly is improperly sealed. In particular, the preferred joint assembly is unable to hold fluid pressure as a dry fit connection or as a partial seal. More specifically, the joint assembly includes a preferred coupler, i.e., a pipe fitting, a pipe end fitting or a modified pipe surface for joining piping segments, that includes a channel to form a leak path in cooperation with the pipe segment surface in an improperly sealed joint connection. Fluid can escape through the channel to identify to a piping system installer, contractor, owner or operator (collectively “operating personnel”) the improper seal, and in particular the absence of a sealant material to form the proper seal in the joint assembly. Accordingly, described herein are methods and systems for detecting and sealing dry fit connections in a piping assembly. Moreover, the inventors' couplers prevent the build up of fluid pressure around a dry fit joint connection absent any or a proper amount of sealant material. By eliminating the ability of a dry fit connection to hold fluid pressure, the connection cannot store potential energy and thus the potential for harm to the surrounding environment and personnel from a dry fit or partial seal connection is eliminated.

In one preferred embodiment, a method is provided for detecting a leak in a pipe assembly. The method includes providing at least one fitting having a channel defining a leak path, pneumatically testing the assembly, and then hydraulically testing the assembly. A method provides for checking the integrity of a fire protection piping system having a plurality of couplers. The method includes pressurizing the piping system, detecting a leak in the piping system, the detecting including flowing fluid from at least one channel in the coupler, sealing the at least one channel, and rechecking the system for a leak. The flowing of fluid includes disposing at least one coupler about at least one pipe segment including placing the at least one channel in communication with the central passageway of the at least one piping segment. Placing the channel in communication with the central passageway further includes defining the depth, width and length of the at least one channel along an inner surface of the coupler. Detecting a leak preferably includes monitoring a pressure drop in the system, and identifying the at least one coupler from which fluid is flowing. Part of the preferred method includes applying a sealant to the coupler and the pipe segment and further altering the channel so as to form a fluid tight seal about the pipe segment.

A method is provided of leak testing a piping system having at least one joint assembly including a pipe fitting with a pipe segment disposed in the fitting. The method includes defining a leak path between the pipe fitting and the pipe element, introducing fluid into the system, and detecting fluid discharge from the leak path. Accordingly, a method of detecting a leak in a pipe assembly preferably includes providing at least one coupler attached to a pipe segment to form the assembly. The coupler includes a channel to define a leak path. The method further includes flowing fluid through the channel so as to detect leak between the at least one fitting and the pipe segment. More preferably, the method provides pressure testing the assembly pneumatically, and pressure testing the assembly hydrostatically, or alternatively, the method can consist of one of pneumatic and hydraulic pressure testing. The detecting of fluid discharge, in the presence of the leak path, includes detection of a pressure drop in the system within a preferred time such as, for example, two minutes of initiating pressure testing. Moreover, wherein introducing the fluid includes pressurizing the system with air to an initial pressure of 10 psi, the pneumatic testing preferably includes detecting a pressure drop in the system through the leak path. The pressure drop having an initial minimum rate of about 0.5 psi per minute. Under the hydraulic pressure testing using an initial pressure of 10 psi, the hydraulic testing includes detecting a minimum 0.5 psi/2 min across all the modeled occupancies.

To facilitate leak detection, a preferred coupler is provided for forming a joint assembly in a fire protection piping system, the coupler includes a substantially tubular wall portion having an outer surface and an inner surface defining a passageway extending along an axis. The coupler further includes an end face extending between the inner surface and the outer surface to define a thickness of the tubular wall portion. A channel is disposed along one of the inner and outer surfaces and in communication with the passageway. The channel has a first configuration for carrying a fluid between an interior of the piping system and an exterior of a piping system. The channel has a second configuration to prevent fluid from being carried between the interior and the exterior of the piping system. The channel is further preferably convertible from the first configuration to the second configuration in the presence of a minimum amount of sealant material. Where the system has an initial internal pressure of about 10 psi of air, the channel in the first configuration provides for decrease in the system pressure at a preferred initial minimum rate of about 0.5 psi per minute. Under the hydraulic pressure testing at 10 psi, the channel configurations preferably provide an initial minimum rate of pressure change of 0.5 psi/2 min.

Further provided is a coupler having an outer surface and an inner surface defining a central passageway along a longitudinal axis. An annular shoulder is engaged with the inner surface and extends radially inward toward the longitudinal axis. The shoulder includes a pair of sidewalls to define an axially extending channel in communication with the central passageway. The channel is preferably alterable to define a fluid-tight seal about a segment. The pair of sidewalls defines a channel depth of the channel in a direction along the longitudinal axis. Preferably, the channel depth is at a maximum at the shoulder, and the coupler further includes a first end face and a second end face. The inner surface further includes an interconnecting surface connecting the pair of sidewalls, the interconnecting surface is substantially radiused relative to the interior of the channel. In one embodiment, the channel can progresses helically about the longitudinal axis. In another embodiment, the channel includes a portion that is configured as a through hole extending from the inner surface and the outer surface and in communication with the remainder of the channel. Alternatively, the entire channel can be defined by a through hole extending from the inner surface to the outer surface substantially perpendicular to the axis of the coupler. In a further embodiment, the coupler further includes a projection along the outer surface so as to define a constant wall thickness through the inner surface and the outer surface.

### BRIEF DESCRIPTIONS OF THE DRAWINGS

The accompanying drawings, which are incorporated herein and constitute part of this specification, illustrate exemplary embodiments of the invention, and, together with the general description given above and the detailed description given below, serve to explain the features of the invention.

FIG. 1 is a schematic view of a residential fire protection system.

FIG. 2 is a flow chart of a method for checking the integrity of the piping system of FIG. 1.

FIGS. 3 and 3A are schematic views of a joint assembly for use in the system of FIG. 1.

FIG. 3B is a cross-sectional schematic view of the joint assembly of FIG. 3B.

FIG. 4 is a cross-sectional view of a preferred coupler for use in the assembly of FIGS. 3A-3B.

FIG. 4A is an end view of the coupler of FIG. 4.

FIG. 4B is a detailed view of the end in FIG. 4A

FIG. 4C is a cross-sectional schematic view of the coupler of FIG. 4.

FIGS. 4D and 4E are alternate end and detailed views of a coupler with a channel.

FIG. 5 is a schematic view of a test assembly for evaluating a coupler.

FIGS. 5A-5D are performance plots of various modeled piping systems incorporating a coupler.

FIG. 5E is a comparative plot between actual test assemblies and a modeled assembly for a coupler.

FIGS. 6A-6C is another illustrative embodiment of a coupler with a channel for use in the joint assembly of FIGS. 3A-3B.

FIGS. 7A-12B are various views of alternate embodiments of a coupler configured as a fitting with a channel.

FIGS. 13-15 are various views of alternate embodiments of a coupler configured as a pipe end fitting with a channel integral with a pipe segment.

FIGS. 16A-17 are various views of alternate embodiments of a coupler configured as a pipe segment with a channel.

### MODE(S) FOR CARRYING OUT THE INVENTION

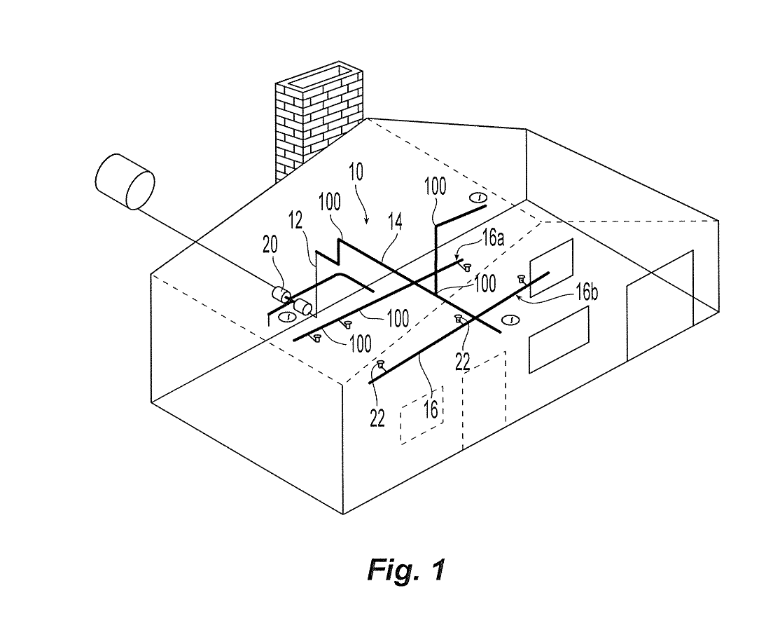

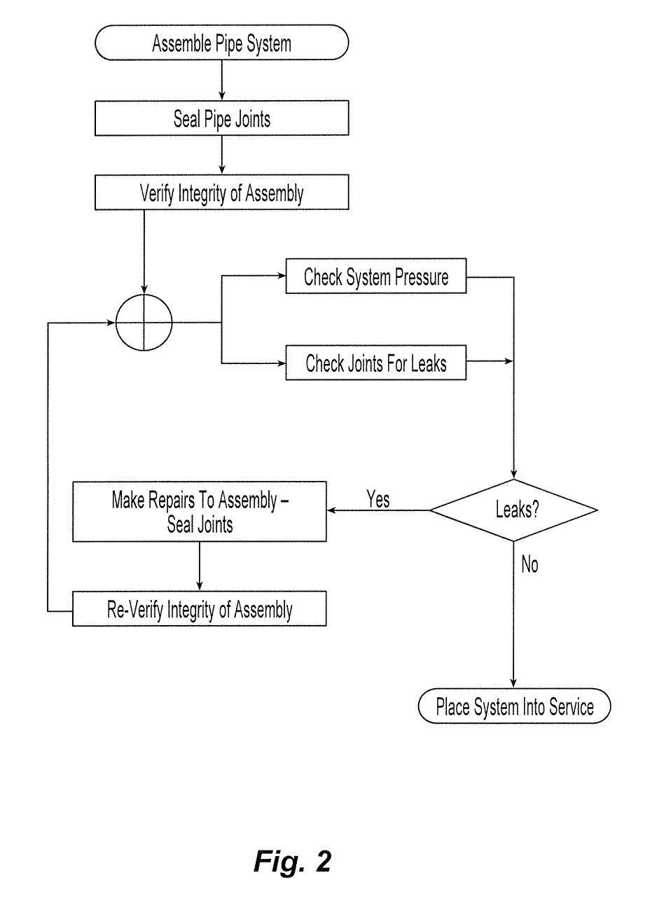

Shown in FIG. 1 is an illustrative embodiment of a preferred piping system 10 for carrying a fluid as either a gas, a liquid or a combination thereof. More specifically shown is a preferred piping network 10 for a fire protection system. The system 10 is preferably constructed from Post Chlorinated Polyvinyl Chloride (CPVC) piping segments and fittings such as for example, Tyco Fire & Building Products TFP Blazemaster® piping systems as shown and described in the “Blazemaster®: Installation Instructions & Technical Handbook” (Rev. 0 Jan. 2005) (Addendum #1/IH-1900 (October 2005)), each of which is incorporated in its entirety by reference. The system 10 includes a network of piping elements, which can include any one of: main lines 12, branch lines 14, sprigs, drops, risers 16, pipe nipples 18, valves 20, sprinklers and/or nozzles 22, and alarm devices. To interconnect and join the various pipe elements, the system 10 preferably includes one or more joint connections or assemblies 100 formed by the connection between a pipe segment and a coupler. The coupler can be any one of a pipe fitting, a pipe end fitting or a modified pipe surface for joining piping segments. Preferably, the system 10 is placed in service as a residential wet pipe sprinkler system, in which automatic sprinklers 22 are attached to the piping system 10 containing water and connected to a water supply so that water discharges immediately from the sprinklers opened by heat from a fire. Alternatively, the system 10 can be configured as a residential dry sprinkler system in which the automatic sprinklers 22 are attached to the piping system 10 containing air or other gas under pressure that is displaced by water upon the actuation of a control valve coupled to the water supply. Such a dry residential fire protection system is shown and described at paragraphs [0024] to [0029] and FIGS. 1-2 of U.S. Pat. No. Publication No. 2006/0021765 which is incorporated in its entirety by reference. Further in the alternative, the preferred system 10 can be any other type of piping system, preferably having plastic piping components. Alternative piping systems preferably having plastic fittings and components can include vent systems, drain systems, pools and spas, and irrigation systems, chemical systems, and potable water systems in which its joint assemblies employ an interference fit in combination with a flowable sealant material to form a fluid-tight sealed connection.

The preferred assembly of the system 10 includes joining two or more pipe elements at a joint assembly 100 using a socket-type coupler with a flowable sealant material, verifying the seal integrity throughout the system and placing the system in service. Shown in FIG. 2 is a preferred method of assembling a piping system and verifying the integrity of the system 10. Preferably, assembly of the system 10 includes, for each assembly of a socket-type joint assembly 100, joining a pipe segment and a coupler, checking the dry fit therebetween, disassembling the connection, applying the sealant about the outer surface of the pipe segment and the inner surface of the coupler, rejoining the elements and allowing the sealant to cure.

The method further preferably includes verifying the integrity of the system by detecting a leak. Preferably, a positive pressure is placed on the system 10, but may alternatively a negative pressure may be placed on the system 10. The method of detecting can include a direct method of leak detection by, for example, observing a leak from one or more joint assemblies 100 after pressurizing the system 10. Alternatively or in addition to, the method of detecting can include an indirect method of leak detection by monitoring one or more pressure gauges coupled to the system 10 for monitoring a pressure loss in the system. If a leak is detected, the preferred method of assembly can include repairing and sealing the leak and re-verifying the integrity of the system 10. If no leak is detected, the system 10 can be placed into service.

A preferred coupler provides means for detecting a leak in a pipe system 10 for use in the preferred method of assembly. More specifically, the preferred coupler, in the absence of an appropriate seal and under positive pressure, directs movement of a fluid from the central interior passageway of the pipe assembly to the exterior environment proximate the pipe assembly through a leak path at least in part defined by the coupler and defined in total by the cooperation between the coupler and the pipe segments. Under a negative pressure and in the absence of an appropriate seal, the preferred coupler continues to draw external atmosphere through the channel. Preferably, the leak path is configured to prevent the pipe system 10 from holding pressure in the absence of an appropriate seal. Operating personnel that detect that the system's failure to maintain a static pressure are thereby alerted to the possibility an improper seal in the joint connections. An improper seal can be a joint connection in which no sealant material is present or where some sealant material, but an insufficient amount, has been applied.

Upon construction of a pipe system 10 having the preferred couplers, the operating personnel verify the integrity of the system 10 by evaluating whether a leak path is formed through which fluid can flow between the system interior and exterior. Specifically, the operating personnel preferably pressure test the piping system in stages. In the first stage, the piping system 10 is pneumatically tested over a pressure range or value, for example, from about, preferably, 1 pound per square inch (psi) to about 15 psi, and preferably at a value of 15 psi The system 10 is checked for the compressed air or gas leaking from preferred couplers using direct and/or indirect visual, tactile or audible means. The operating personnel may then properly seal any improperly sealed joint assemblies 100 that were detected, and after which, the operating personnel can again pneumatically test the system over the preferred pressure range or value, from about, preferably, 1 pound per square inch (psi) to about 15 psi, and preferably at a value of 15 psi, to verify that the repairs were satisfactory.

A second stage of pressure testing preferably includes hydraulic testing and more preferably hydrostatic testing of the system 10, at a preferred pressure of about 200 psi. More preferably, the second stage of pressure testing provides for hydraulic testing at hydrostatic testing pressures as defined in National Fire Protection Association (NFPA) Standard NFPA-13, Chapter 24 (2007), entitled, “Standards for Installation of Sprinkler Systems: Systems Acceptance,” which is incorporated by reference in its entirety.

After pressurizing the system to the desired hydrostatic testing pressure, the system can be checked for liquid discharge from the preferred couplers using direct and/or indirect visual, tactile or audible means. The operating personnel can again properly seal any improperly sealed joint connections that were further detected under the second stage of pressure testing, and then may again preferably hydraulically test the system under the preferred hydrostatic pressure range. It should be understood that any pressure range or specific pressure value can define the initial pneumatic pressure range or the hydraulic pressure range, provided that the initial pneumatic and hydraulic pressures are sufficient so as to move the corresponding fluid from the central interior passageway of the pipe assembly to the exterior environment proximate the pipe assembly through the leak path at a rate that is detectable by direct or/indirect means. It should be further understood that the operating personnel provide for an appropriate amount of time between performing any sealing operation and pressure test to allow sufficient time for the sealant to weld, meld, bond or otherwise form the joint connection. With all the joints properly sealed and the system checked for its integrity, the system can be filled with water or other fluid and placed into service.

Alternatively to performing the second stage of hydraulic pressure testing after the initial pneumatic test, a second stage of pneumatic testing can be performed in which the testing pressure is increased or greater than the initial test pressure test stage provided the second pneumatic test pressure is suitable for the piping application. Again, the system can be checked for the compressed air or gas leaking from the preferred couplers using direct and/or indirect visual, tactile or audible means. The operating personnel can again properly seal any improperly sealed joint connections that were further detected under the higher pressure range, and then they may again pneumatically test the system under the test pressure for the second stage.

The preferred couplers provide a substantially rapid and verifiable mechanism for detecting an improperly sealed joint connection in a piping system. More specifically, the preferred couplers are configured with a channel that, in the absence of a proper seal, provides for a leak path through which fluid can immediately flow between the interior of the system and the exterior of the system 10 to provide at least one of a relatively quick indirect and direct leak indicator for the operating personnel. The compressed liquid, gas, air or other fluid leaking from a preferred coupler's channel, identifies for the operating personnel an improperly sealed joint. Moreover, it is believed that the preferred couplers provide a preferred means with which to perform pressure testing of a piping system 10 preferably in the method described above. In particular, the preferred couplers' channels, in the absence of a proper amount of sealant material, result in detectable pressure drop in the system 10 preferably within two minutes of initiating the system pressure test. Moreover, because the preferred couplers prevent the build up of fluid pressure around an improperly sealed joints, the preferred couplers remove the potential energy around the joined pipe fittings or segments absent a properly formed seal. This mechanism can prevent improperly joined pipe fittings or segments from violently failing or rupturing and becoming projectiles capable of causing property damage and/or serious injury to surrounding personnel.

A preferred coupler for forming a joint assembly 100 with a pipe segment is configured to detect and identify an improper seal assembly by preventing the dry fit connection between the mating surfaces of the pipe segment and the preferred coupler in the joint 100 from holding pressure, absent an adequate amount of sealant material, and instead allows the fluid to escape to atmosphere. In the presence of an adequate amount of sealant material, the preferred coupler forms a fluid tight seal about the pipe segment. The sealant material can be, for example, a cement, solvent cement, epoxy, solder or other flowable material that is used to reconstitute, chemically weld, bond or otherwise permanently join the coupler to one or more piping segments. Exemplary sealant materials for use with the couplers includes (i) Blazemaster CPVC Cement TFP-400 Red Heavy Bodies or (ii) Blazemaster CPVC Cement TFP-500, each described at pages 43-50 of the “Blazemaster®: Installation Instructions & Technical Handbook” (Rev. 0 Jan. 2005), which is incorporated by reference in its entirety, or their equivalents. Because the preferred coupler indicates an improper fluid seal by leaking to atmosphere the fluids conveyed through the joint assembly, the preferred coupler does not permit the build up of pressure around the joint 100 in the absence of a proper chemical seal. Furthermore, the coupler is preferably configured to provide a sufficient interference fit between the joined surfaces of the joint assembly so as to avoid unnecessary pooling of sealant material between pipe elements, as recommended at page 33 of the “Blazemaster®: Installation Instructions & Technical Handbook” (Rev. 0 Jan. 2005).

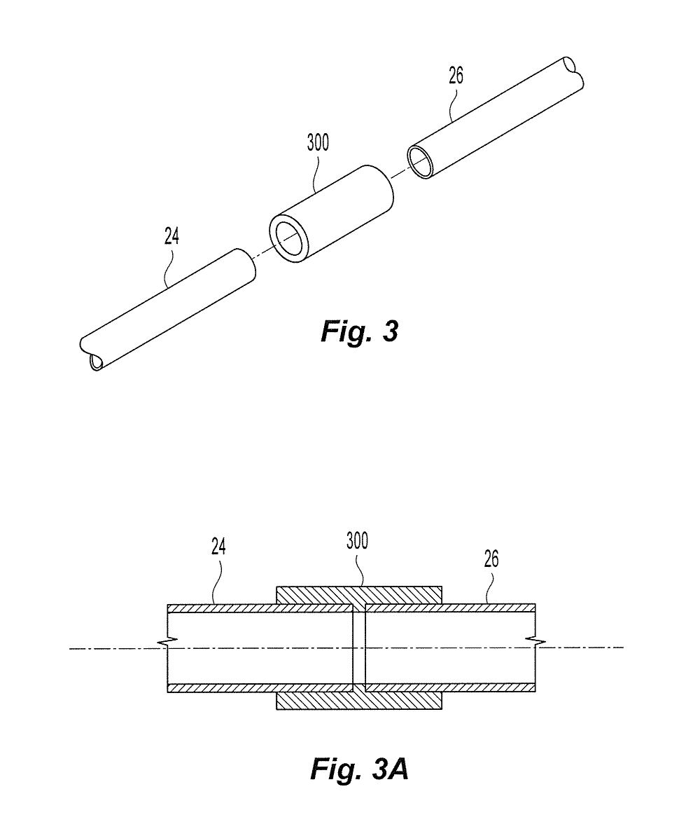

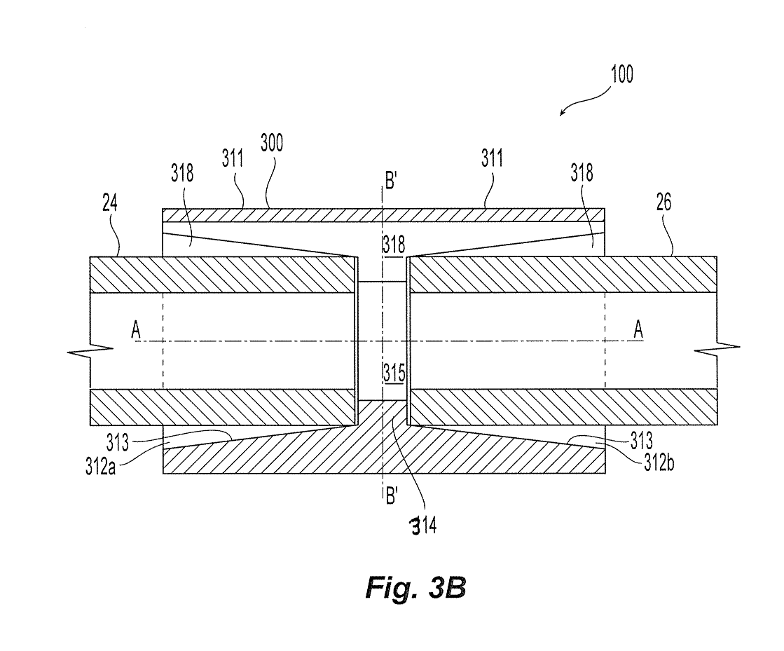

The preferred coupler includes a substantially tubular wall member defining one or more sockets to receive a pipe segment or element such as a pipe, fitting or adapter. Referring to FIGS. 3 and 3A, the preferred coupler shown and described herein substantially throughout for the purpose of illustration and explanation is a pipe fitting 300 configured as a coupling to join a first pipe segment 24 and a second pipe segment 26 preferably by a socket-type connection. The fitting 300 defines a longitudinal axis A-A, along which joined pipe segments 24, 26 would be substantially axially aligned with one another. The pipe fitting 300 can be alternatively configured as an elbow defining a bend angle ranging for example, between 30°-90°. Thus the preferred fitting 300 can be configured as any one of a 45°, 60°, 90° or other angled elbow. The pipe fitting 300 can also be configured to couple more than two pipe segments and thus the pipe fitting 300 can be configured as any one of a cross type, Tee-shaped or Y-shaped fitting. Generally, the preferred fitting 300 and its various features described herein as a coupling for the purpose of illustration can be of any desired configuration for coupling two or more pipe segments, and thus can be configured in any one of the fittings shown at pages 3-6 of Tyco Fire & Building Products data sheet entitled, “TFP1915: Blazemaster CPVC Fire Sprinkler Pipe & Fittings Submittal Sheet” (January 2006) which is incorporated in its entirety by reference. Thus the fitting 300 can be configured, for example, as: (i) a tee; (ii) a reducing tee; (iii) a cross or reducing cross; (iv) a 90° elbow or reducing elbow; (v) a 45° elbow; or (vi) a reducer coupling. Alternatively, the fitting 300 can be configured to form an end cap at the end of a single pipe segment. Further in the alternative, the fitting 300 can be configured as a grooved coupling adapter for coupling plain end pipe and grooved pipe or an appropriately configured male or female adapter for threaded pipe. Such an adapter can be configured as any one of (i) a straight coupling; (ii) a tee; (iii) a back-to-back tee; (iv) a back to back cross or (v) an elbow. In addition, the fitting 300 can be configured as an adaptor for coupling to a sprinkler or other fluid distributing device. More generally, the preferred coupler can be shaped or configured to join pipe segments as any known fitting.

Referring to FIG. 3B, the preferred coupler again illustrated as fitting 300, includes an outer surface 311 and an inner surface 313 defining the interior passageway 315 of the fitting 300. For example, in the fitting 300, the inner surface defines a central passageway 315 extending along the axis A-A. Dividing the interior passageway 315 of the fitting are one or more circumferential shoulders or rings 314 preferably formed integrally with the inner surface 313 and more preferably integrally formed with the fitting 300. The divided passageway 315 preferably defines the various sockets for receipt of pipe segments, fittings or adapters. For example, in the fitting 300 shown in FIG. 3B is a first socket 312a for receipt of the first pipe segment 24 and a second socket 312b for receipt of the second pipe segment 26. Each shoulder 314 of the fitting 300 defines a central opening such that the interior passageway 315 is continuous and communication is provided between the pipe segments 24, 26, as schematically shown in cross-section. Preferably, each of sockets 312a, 312b and the inner surface 313 is configured to form an interference fit at one or more circumferential points with the outer surface of the pipe segments 24, 26. For example, the sockets 312a, 312b are further defined by the preferably tapering inner surface 313 (not drawn to scale) so as to form a substantially circumferential interference fit about the pipe segments 24, 26. The taper of inner surface 313 can define an angled surface that limits axial progression of a pipe segment 24, 26 so as to define a space between the end face of the pipe segments 24, 26 and the shoulder 314. Alternatively, the end faces of the pipe segments can engage the shoulder 314 to further limit axial travel of the pipe segments 24, 26 through the fitting 300.

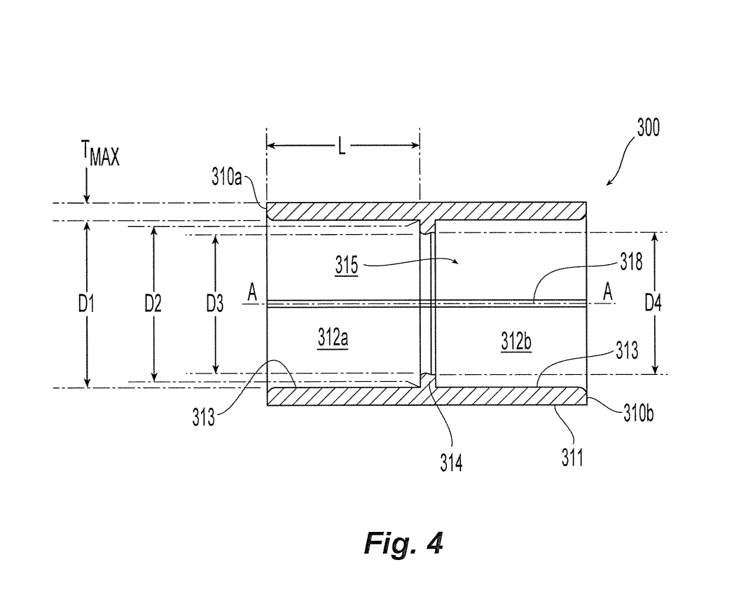

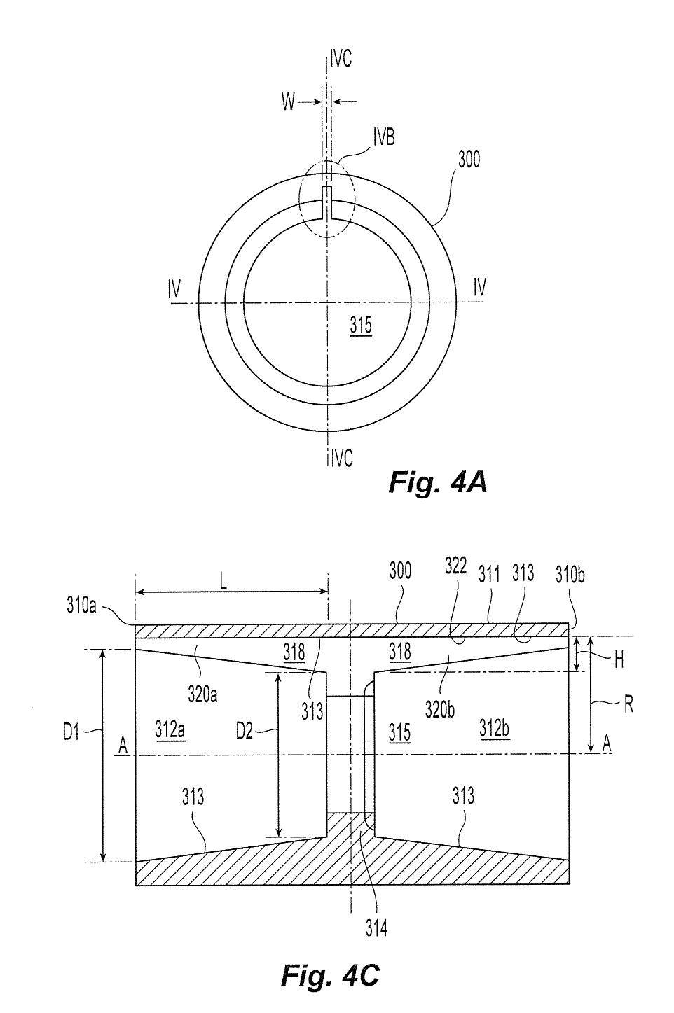

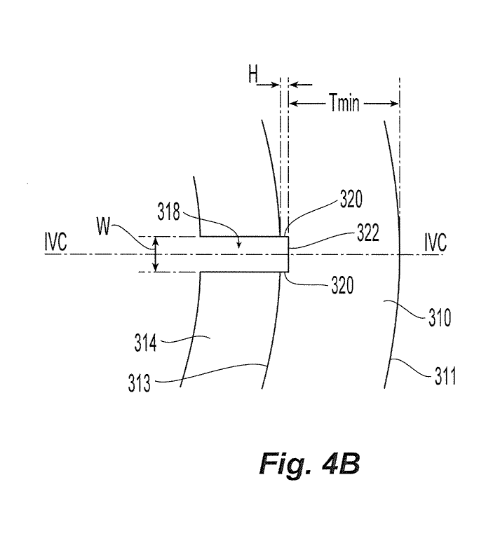

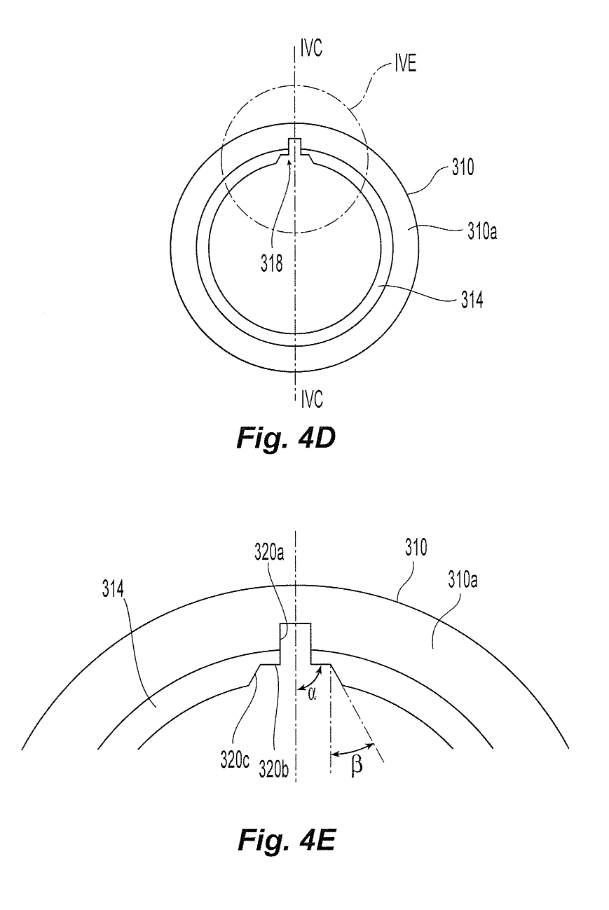

Referring to FIG. 4, the preferred fitting 300 is shown more specifically as a nominal one inch coupling having an overall length preferably of about 2.50 inches. The outer surface 311 of the fitting 300 preferably defines a substantially tubular portion proximate the opening to each socket in the fitting 300. As previously described, the inner surface 313 defines the sockets of the 312a, 312b of the fitting 300, each of which are preferably configured similarly. With specific reference to the socket 312a, the inner surface 313 preferably tapers narrowly from the end face 310a of the fitting 300 to the shoulder 314 to define a socket length L preferably about 1.19 inches. Where, for example, the fitting 300 is a preferred nominal one inch coupling, the taper of the inner surface 313 further preferably defines a first diameter D1 at the entrance of the socket 312a of about 1.325 inches and a second diameter D2 at the base or bottom of the socket 312a, proximate the shoulder 314 of and measuring about 1.310 inches. Accordingly, for any nominal size fitting, in each socket the second diameter D2 is smaller than the first diameter D1 so as to define a preferred taper defined by the absolute value of the difference between the first and second dimension divided by the socket length. Therefore, the inner surface 313 preferably defines a taper of about |(D2−D1)|/L for each socket of the preferred fitting 300 equivalent to about 0.015 inches/1.19 inches or about 0.012.

The shoulder 314 preferably extends radially inward toward the central axis A-A by an amount sufficient to present a surface to inhibit the axial migration of a pipe segment toward the center of the fitting yet sufficiently low in profile so as to provide a desired fluid flow therethrough at a desired pressure and/or fluid velocity. Preferably, the shoulder 314 defines an internal diameter D3 of the fitting 300 to be about ninety-four percent of the first diameter D1 or about 1.25 inches and is more preferably about 1.10 inches in diameter. Either surface of the shoulder extending perpendicularly to the central axis A-A can be countersunk such that the shoulder 314 defines another internal diameter D4, which, for example, in the preferred fitting 300, preferably measures about 1.11 inches. The counterbore of the surface is preferably to a depth of about 0.035 inches. The dimensions of the sockets 312a, 312b can further follow the schedule of dimensions shown in Table B entitled “ASTM Dimensions for CPVC fitting in inches” at page 19 of the “Blazemaster®: Installation Instructions & Technical Handbook” (Rev. 0 Jan. 2005) (Addendum #1/IH-1900 (October 2005)), which is incorporated by reference, for a range of nominal size fittings ranging from ¾ inches to three inches. In the alternative, the sockets of the fitting may be correspondingly dimensioned where the nominal size of the fitting varies from about ½ inch to about 18 inches.

The fitting 300 further includes one or more channels 318 to define a leak path for fluid conveyed through the joint assembly 100. More specifically, the fitting 300 preferably includes a channel 318 to define a leak path or passageway over the outer surfaces of the pipe segments 24, 26 through which a gas or liquid contained in the pipe segments 24, 26 can escape to atmosphere. The channel 318 preferably forms a single discontinuity in the interference fit between the preferably smooth circular inner surface 313 and the outer surface of pipe segments 24, 26 so as to be in communication with the central interior passageway 315 of the fitting. Accordingly, the channel 318 is in communication with sockets 312a, 312b such that fluid flowing from the ends of the pipe segments 24a, 24b into the central portion of the interior passageway 315 of the fitting 300 can escape to atmosphere. In forming a fluid-tight sealed joint assembly for service in a piping system, the sealant material, preferably one of (i) Blazemaster CPVC Cement TFP-400 Red Heavy Bodies or (ii) Blazemaster CPVC Cement TFP-500, each described at pages 43-50 of the “Blazemaster®: Installation Instructions & Technical Handbook” (Rev. 0 Jan. 2005), is applied to the outer surface of the pipe segments 24, 26 and along the inner surface 313 of the sockets 312a, 312b. For a given configuration of pipe segments 24, 26 and sockets 312a, 312b, a sufficient amount of sealant material fills, seals, melds, welds, deforms, reconstitutes and/or collectively alters the channel 318 of the fitting 300 so as to prevent the escape of fluid to atmosphere and forms the fluid tight seal about the joint assembly.

Because the channel 318 allows a fluid to escape to atmosphere in the event of an improper seal, the channel 318 provides any one of the joints 100 in the system 10 with an indicator to operating personnel of an incomplete or failed fluid tight joint assembly. More specifically, the operating personnel is made immediately aware of the lack of adequate or complete absence of sealant material in the socket 312a or socket 312b by the direct visual, tactile or audible indication of fluid flowing from either channel 318 and/or the failure of the fitting 300 to maintain pressure. Indirect methods of detecting fluid discharge from the channel 318 can be employed. For example, in the method described above in which operating personnel are pneumatically and/or hydraulically checking the system 10, the operating personnel monitor a pressure gauge to observe whether the system 10 can hold and maintain a given pressure. If the system is unable to hold a constant pressure, the joint assemblies 100 of the system are inspected to determine if fluid was being vented from the channels 318 due to an improper seal at the fitting 300. For example, where the system 10 contains a liquid, a material can be applied to the fitting 300 and as liquid discharges from the channel 318 and contacts the material, the liquid and the material can react to provide a visual or tactile indication of an incomplete seal.

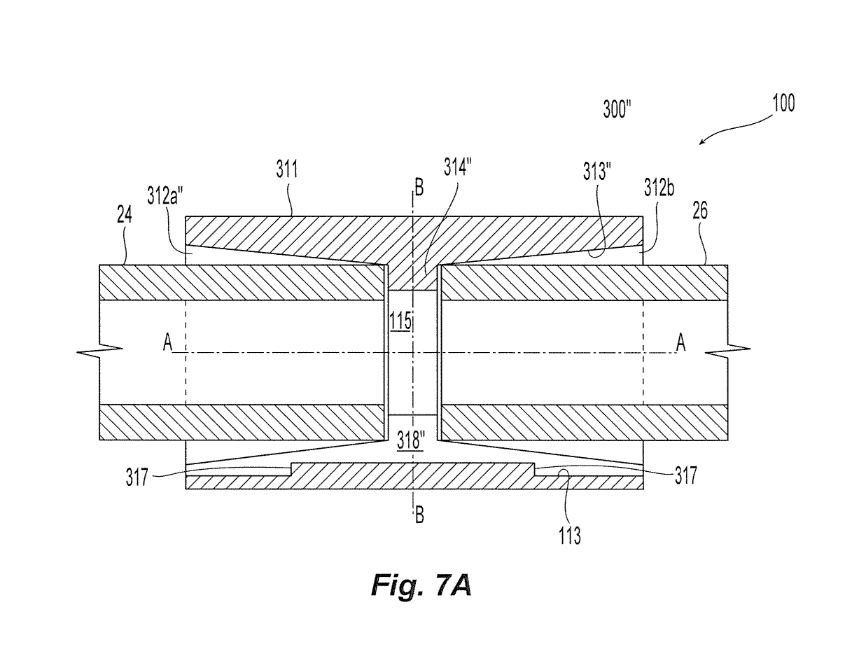

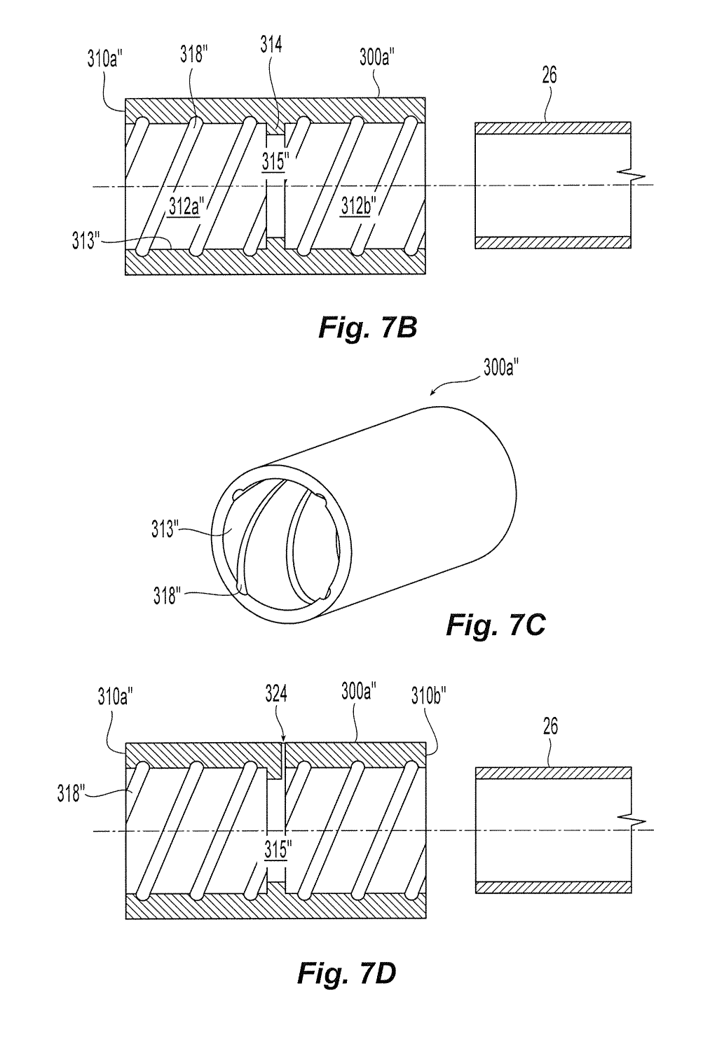

As seen in FIGS. 4B and 4C, the channel 318 extends to each side of the shoulder 314 and preferably to an end face 310a, 310b of the fitting 300. More preferably, the channel 318 extends axially inward of the surface of the shoulder 314 to define a channel length greater than the socket length L, and more preferably, the channel 318 extends the entire axial length of the coupling 300 through the shoulder 314. Where the fitting 300 has more than one socket, a channel 318 preferably extends through a shoulder 314 so as to place a portion of the channel 318 in one socket in communication with a portion of the channel 318 in at least one other socket. Extending a channel 318 axially beyond the surfaces of the shoulder 314 can further ensure that the channel 318a, 318b remains patent and cannot be sealed off solely by the mere engagement between the end faces of the pipe segments 24, 26 and the lateral surfaces of the shoulder 314. The channel 318 is more particularly defined by a pair of spaced and preferably substantially parallel sidewalls 320 and an interconnecting surface wall 322 extending therebetween. Although each of the sidewalls 320 and the interconnecting surface wall 322 are shown as substantially planar, one or more of the channel surfaces 320, 322 are preferably radiused and more preferably concave relative to the channel interior, as seen, for example, in the embodiment shown in FIG. 7C.

The sidewalls 320 of the channel 318 are spaced apart to define a channel width W preferably measuring about 0.045 inches and more preferably about 0.060 inches. The inner surface 313 and the sidewalls 320 further define the depth or height profile H of the channel 318. Preferably, the height of the channel 318 at the end face 310a is about 0.010 inches and more preferably about 0.025 inches. The depth profile H of the channel 318 further preferably increases toward the center of the fitting with the deepest part of the channel being at the shoulder 314, where, for example, in the channel depth H is about 0.07 inches. More specifically with reference to the cross-sectional view of the channel 318 in FIG. 4C, shown in particular with respect to the socket 312b, the inner surface 313 further defines the height H of the channel 318. Where the interconnecting surface wall 322 of the channel 318 is substantially parallel to the longitudinal axis A-A of the fitting 310, the channel height profile H tapers narrowly from the shoulder 314 to the end face 310b of the fitting 310. The channel 318 can alternatively or additionally be characterized by a radial distance R preferably measured from the central axis A-A to the interconnecting surface wall 322. Alternatively, the interconnecting surface 322 of the channel 313 can parallel the taper of the inner surface 313 of the socket 312b so as to define a constant height profile H over the length of the channel 318. Further in the alternative, the interconnecting surface 322 can define a non-planar profile such as, for example, a wave-form, along its axial length. The height H of the channel 318 can vary symmetrically about a portion of the fitting 310, or alternatively the height H can vary over the entire length of the fitting.

The sidewalls 320 of the channel 318 are shown in FIG. 4B as being parallel to one another, but they may alternatively define an angle with respect to one another. Accordingly, the channel width W is preferably constant, or alternatively can vary along the depth of the channel 318. The resultant narrowing channel 318 can create a venturi effect so as to eject any fluid in the channel 318 with some appreciable velocity. For example, the sidewalls 320 can define an angle with respect to the axis defined by the end face of the fitting 310. Moreover, the angle can vary over the height of the channel. Shown in FIG. 4D and FIG. 4E is a detailed view of another channel 318 formed by sidewalls 320 that can be provided or formed in any one of the couplers shown and described herein. More preferably, the portion of the sidewall 320 that forms or is integral with the shoulder 314 of the fitting 310 defines one or more angles relative to the radially extending vertical axis that is defined by the end face 310a or shoulder 314 of the fitting 310 and preferably bisecting the channel 318. The sidewall 320 preferably includes a first portion 320a that is parallel to the vertical axis of the end face and more preferably includes a second portion 320b that defines an angle α relative to the vertical axis end face 310a. The angle α can range between about forty-five degrees to about one hundred degrees and is preferably about ninety degrees. The sidewall 320 further preferably includes a third portion 320c that defines a second angle β relative to the vertical axis of the end face 310a. The second angle β can range from about ten degrees to about fifty degrees and is preferably about forty-five degrees. The varying angles of the sidewall 320 varies with the radially extending bisecting axis of the channel 318 to further preferably define at least a portion of the channel 318 for communication with a portion of a pipe segment disposed in the socket of the fitting 310 such that the velocity and/or pressure of the fluid (liquid or gas) can vary along the height H of the channel 318. Shown in particular with respect to FIG. 4E, the profile of the channel 318 includes right and obtuse angles formed by the corners along the channel perimeter. More preferably, the corners, turns or bends connecting the surfaces of the channel are preferably radiused or rounded.

Referring to FIG. 4B, in the region of the channel 318, the interior channel surface 322 and the outer surface 311 define the minimum wall thickness Tmin of the fitting 300 measuring from about 0.12 to about 0.16 inches and is more preferably about 0.14 inches. The minimum wall thickness of the fitting is preferably configured such that the fitting, when appropriately tested, can satisfy and/or exceed requisite industry standards such as, for example, (i) American Society for Testing and Materials (ASTM) Standard Specification F 438 Standard Specification for Socket-Type Chlorinated Poly(Vinyl Chloride) (CPVC) Plastic Pipe Fittings, Schedule 40; (ii) ASTM F 439 Standard Specification for Chlorinated Poly (Vinyl Chloride) (CPVC) Plastic Pipe Fittings, Schedule 80; (iii) ASTM F1970-05 Standard Specification for Special Engineered Fittings, Appurtenances or Valves for use in Poly (Vinyl Chloride) (PVC) or Chlorinated Poly (Vinyl Chloride) (CPVC) Systems; and/or those provided in ASTM International publication, Vol. 08.04 Annual Book of ASTM Standards 2003: Section Eight Plastics-Plastic Pipe and Building Products (2003). While satisfying such industry standards, the preferred fitting 300 also preferably minimizes the material required for its construction. Accordingly, the preferred fitting 300 further defines an overall maximum wall thickness Tmax of about 0.15 inches and is more preferably about 0.147 inches, shown for example, in FIG. 4. Preferably, the minimum wall thickness Tmin is at least eighty-five percent (85%) of the maximum wall thickness Tmax. The preferred one inch nominal coupling preferably weighs no more than about 0.07 lbs. While preferred wall thickness dimensions can be identified to comply with applicable industry standards and/or minimize material requirements, the wall thicknesses are appropriately dimensioned to create a channel or leak path which can define a void in conjunction with the outer surface of a pipe segment through which fluid can readily leak and provide a visual indicator of an improper seal, and further form an adequate fluid tight sealed connection upon application of an appropriate amount of sealant material.

More preferably, the channel 318 is dimensioned such that the channel or leak path can define a void in conjunction with the outer surface of a pipe segment through which fluid can readily leak and provide a visual indicator of an improper seal, and further form an adequate fluid-tight sealed connection upon application of an appropriate amount of sealant material. The channel volume is preferably defined by the channel length, the channel width W and the height profile H. The total channel volume of the fitting 300 can be further defined by the number of channels 318 radially disposed about a socket 312a, 312b. Although only a single channel 318 is shown at the end face 310b in FIG. 4A of the fitting 300, a plurality of channels 318 may be radially disposed about the central axis A-A of the fitting 300 to provide multiple indicators to the operating personnel regarding the adequacy of the seal in the joint assembly 100 as described above. The inner surface between channels 318 preferably defines a constant radial distance from the axis of the fitting 300 so as to present a substantially smooth inner surface 313. Shown in Table 1a, is a schedule of channel dimensions depth H and width W, measured at the end face 310, that can be used over a range of nominal size fittings.

TABLE 1a

| Channel Depth - | Channel Width - | Channel Depth - | Channel |
|---|---|---|---|
| H (in.) | W (in.) | H (in.) | Width - W (in.) |
| 0.060 | 0.060 | 0.050 | 0.015 |
| 0.015 | 0.100 | 0.025 | 0.025 |
| 0.025 | 0.060 | 0.005 | 0.100 |
| 0.025 | 0.030 | 0.035 | 0.015 |
| 0.025 | 0.020 | 0.015 | 0.035 |
| 0.050 | 0.025 | 0.005 | 0.080 |
| 0.035 | 0.035 | 0.025 | 0.015 |
| 0.015 | 0.080 | 0.015 | 0.025 |
| 0.015 | 0.060 | 0.005 | 0.060 |
| 0.025 | 0.035 | 0.015 | 0.015 |
| 0.035 | 0.025 | | |

Although the channel height H profile and the width W can remain constant over a range of nominal fitting sizes, the channel length, the channel width W and/of the channel height H can vary with the fitting size to preserve a constant dimensional relationship. Where for example, the dimensions of the preferred channel 318 of one socket 312 in the preferred nominal one inch fitting 300 define a height-to-length ratio H:L of about 0.008, the channel length and height H can be dimensioned accordingly for a fitting of lesser or greater nominal size to preserve the preferred ratio. Shown in Table 1b below is an exemplary schedule of dimensions for a channel 318 in which one or more dimension such as, for example, channel width W, vary with the nominal size of the fitting 300.

TABLE 1b

| | | | | | MAXIMUM | |
|---|---|---|---|---|---|---|
| NOMINAL | FIRST | SECOND | MINIMUM | CHANNEL | CHANNEL | CHANNEL |
| PIPE SIZE | DIA. | DIA. | LENGTH | RADIUS | HEIGHT | WIDTH |
| (IN.) | D1 | D2 | L (IN.) | R (IN.) | H (IN.) | W (IN.) |
| 0.75 | 1.058 | 1.046 | 0.719 | 0.567 | 0.038 | 0.076 |
| 1 | 1.325 | 1.310 | 0.875 | 0.707 | 0.044 | 0.088 |
| 1.25 | 1.670 | 1.655 | 0.938 | 0.882 | 0.047 | 0.094 |
| 1.5 | 1.912 | 1.894 | 1.375 | 1.023 | 0.067 | 0.134 |
| 2 | 2.387 | 2.369 | 1.500 | 1.267 | 0.073 | 0.146 |
| 2.5 | 2.889 | 2.868 | 1.750 | 1.537 | 0.092 | 0.184 |
| 3 | 3.516 | 3.492 | 1.875 | 1.858 | 0.100 | 0.200 |

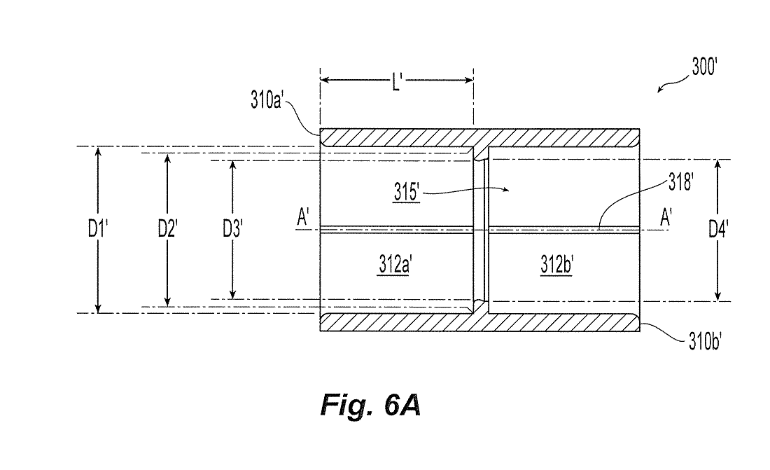

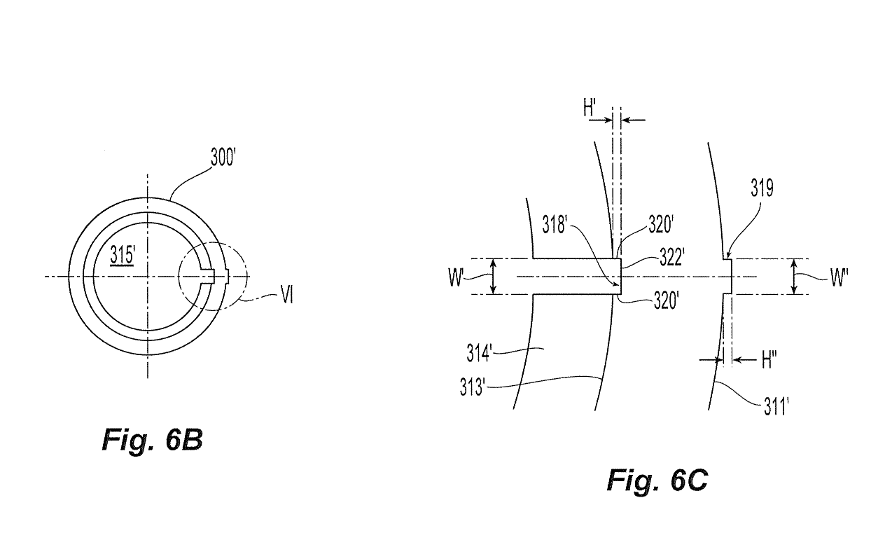

FIGS. 6A-6C, show another alternative coupler embodied as a fitting 300′ having the channel 318′. The fitting 300′ is a coupling in which its internal configuration and overall length is substantially similar to the previously described fitting 300. In particular the preferred fitting 300′ has an overall length of about 2.50 inches to join a first pipe segment 24 and a second pipe segment 26 preferably by a socket-type connection. The fitting 300′ defines a longitudinal axis A′-A′, along which joined pipe segments 24, 26 would be substantially axially aligned with one another.

The preferred fitting 300′ includes two or more sockets 312a′, 312b′ to receive a pipe element such as a pipe, fitting or adapter. The coupler 300′ includes an outer surface 311′ and an inner surface 313′ defining a central passageway 315′ extending along the axis A′-A′. Dividing the sockets 312a′, 312b′ is a circumferential shoulder or ring 314′ preferably formed integrally with the inner surface 313′ and more preferably integrally formed with the fitting 300′. The shoulder 314′ defines a central opening such that the central passageway 315′ is continuous and communication is provided between the pipe segments 24, 26. Preferably, each of sockets 312a′, 312b′ are similarly configured and along with the inner surface 313′ are further configured to form an interference fit at one or more circumferential points with the outer surface of the pipe segments 24, 26. For example, the sockets 312a′, 312b′ are further defined by the preferably tapering inner surface 313′ so as to form a substantially circumferential interference fit about the pipe segments 24, 26. The taper of inner surface 313′ can define an angled surface that limits axial progression of a pipe segment 24, 26 to define a space between the end face of the pipe segments 24, 26 and the shoulder 314′. Alternatively, the end faces of the pipe segments can engage the shoulder 314′ to further limit axial travel of the pipe segments 24, 26 through the fitting 300′.

The fitting 300′ further includes one or more channels 318′ to define a leak path for fluid conveyed through the joint assembly. More specifically, the fitting 300′ preferably includes a channel 318′ to define a leak path over the outer surfaces of the pipe segments 24, 26 through which a gas or liquid contained in the pipe segments 24, 26 can escape to atmosphere. The channel 318′ can form a discontinuity in the interference fit between the inner surface 313′ and the outer surface pipe segments 24, 26 so as to be in communication with the central passageway 315′. Accordingly, the channel 318′ is in communication with sockets 312a′, 312b′ such that fluid flowing from the ends of the pipe segments 24a, 24b into the central passageway 315′ of the fitting 300′ can escape to atmosphere. As with the previously described fitting 300, the fitting 300′ forms a fluid tight joint assembly using a preferably flowable sealant material as discussed above.

The inner surface 313′ preferably tapers narrowly from the end face 310a′ of the fitting 300′ to the shoulder 314′ to define a socket length L′ preferably about 1.19 inches. The taper of the inner surface 313′ further preferably defines a first diameter D1′ at the entrance of the socket 312a′ of about 1.325 inches and a second diameter D2′ at the base or bottom at the socket 312a′ proximate the shoulder 314′ of about 1.310 inches. Accordingly, the second diameter D2′ is preferably smaller than the first diameter D1′. The shoulder 314′ located along the inner surface 313′ preferably extends radially inward toward the central axis A′-A′ by an amount so as to present a surface to inhibit the axial migration of a pipe segment toward the center of the fitting yet sufficiently low in profile so as to provide a desired fluid flow therethrough at a desired pressure and/or fluid velocity. Preferably, the shoulder 314′ defines an internal diameter D3′ of the fitting 300′ to be about ninety-four percent of the first diameter D1′ or about 1.25 inches and is more preferably about 1.10 inches in diameter. Either of the surfaces of the shoulder extending perpendicularly to the central axis A′-A′ can be countersunk such that the shoulder 314 defines another internal diameter D4′ of the fitting 300 preferably measuring about 1.11 inches. The counterbore of the surface is preferably to a depth of about 0.035 inches.

As seen in FIG. 6C, the inner surface 313′ more particularly defines, to each side of the shoulder 314′, the channel 318′ by a pair of spaced and preferably substantially parallel sidewalls 320′ and a surface wall 322′ extending therebetween. Referring again to FIG. 6A, the channel 318′ preferably axially extends away from the shoulder 314′ the length of the socket 312a′, 312b′ to the end face of the fitting 310a′, 310b′.

The sidewalls 320′ of the channel 318′ are spaced apart to define a channel width W′ preferably measuring about 0.045 inches and more preferably about 0.060 inches. The inner surface 313′ and the sidewalls 320′ further define the depth or height H′ of the channel 318′. Preferably, the maximum height of the channel 318′ in the region of the socket 312a′, 312b′ is about 0.010 inches and more preferably about 0.025 inches, and the channel volume is preferably defined by the channel length L′, the channel width W′ and depth H′. The channel 318′ can follow the schedule of dimensions, depth H′ and width W′, measured at the end face 310′, as provided in Table 1a for a range of nominal size fittings. Although the channel height H′ and the width W′ can remain constant over a range of nominal fitting sizes, the channel length L′, the channel width W′ and/of the channel height H′ can vary with the fitting size to preserve a constant dimensional relationship. Where for example, the dimensions of the preferred channel 318′ in the preferred nominal one inch fitting 300′ define a height-to-length ratio H′:L′ of about 0.008, the channel length L′ and height H′ can be dimensioned accordingly for a fitting of lesser or greater nominal size to preserve the preferred ratio. More preferably, the channel 318′ is dimensioned such that the channel or leak path can define a void, in conjunction with the outer surface of an inserted pipe segment, through which fluid can readily leak and provide a visual indicator of an improper seal, and further form an adequate fluid=tight sealed connection upon application of an appropriate amount of sealant material.

The total channel volume of the fitting 300′ can be further defined by the number of channels 318′ radially disposed about a socket 312a′, 312b′. Although only a single channel 318′ is shown at the end face 310b′ in FIG. 6A of the fitting 300′, a plurality of channels 318′ may be radially disposed about the central axis A-A of the fitting 300′ to provide multiple indicators to the operating personnel regarding the adequacy of the seal in the joint 300′ as described above.

The fitting 300′ is preferably a Schedule 40 CPVC nominal one inch coupling.

The interior surface 313′ and the outer surface 311′ preferably define a constant, minimum, wall thickness preferably measuring about 0.14 inches. Accordingly in the region of the channel 318′, the outer surface 311′ of the fitting 300 forms a projection 319′ preferably having a width W″ and a height H″ and axial length to define a volume to provide the constant or minimum wall thickness. The constant wall thickness of the fitting is preferably configured such that the fitting, when appropriately tested, can satisfy and/or exceed requisite industry standards such as, for example, ASTM Specification F438-02.

The preferred couplers described herein throughout are appropriately Schedule-40 or Schedule-80 constructed from CPVC material such as, for example, the CPVC material described in the Lubrizol Corp. Product Data Sheets: (i) TempRite® 3205 (2003) or (ii) TempRite® 3205 (2003) which are incorporated by reference in its entirety, or alternatively Poly Vinyl Chloride (PVC) material. The preferred method of forming the fittings 300 is by general injection molding using a injection molding process such as, for example, generally described in Noveon Inc. publication entitled, “TempRite® CPVC Material Solutions: General Injection Molding Guide” (January 2003), which is incorporated by reference in its entirety. Preferably, the injection process includes using a mold that defines the inner surface 313 and the axially extending central passageway of the preferred fitting 300. The cavity surface of the mold forming the inner surface 313 further includes axially extending ridges or projections to define one or more channels 318 described above. Preferably, the fittings 300 are further constructed in accordance with applicable ASTM standards including F438-02 defining SDR (Standard Dimension Ratio) 13.5 dimensions, so as to define a preferred ratio of outside diameter to wall thickness of the fitting, ASTM F 439, or ASTM F 1970. Accordingly, the channel 318 is cut so as to preferably define a channel height H to wall thickness ratio of about ⅓.

Alternatively, the preferred fittings or end fittings can be constructed from either one of copper or steel material and/or used in combination copper or steel pipe segments to form a chemically sealed or soldered piping assembly. A preferred copper-to-steel (CTS) fitting and/or assembly can be configured for a range of nominal pipe diameters, preferably ranging from about ¼ inch to about 24 inches. Although the preferred fittings and assemblies described herein are well suited for fire protection applications, it should be understood that the preferred couplers can be used in alternative mechanical/plumbing or piping residential, commercial or industrial applications. Alternatively to forming the preferred channels described herein by way of injection molding or extrusion, the channels can be formed at the time of installation of post-fabrication of a CPVC plastic fitting or piping element. Specifically, a channel can be hand or machine cut along an applicable surface of the fitting or pipe segment sufficiently deep to form the desired channel, yet shallow enough to avoid unnecessary pooling of the sealant material.

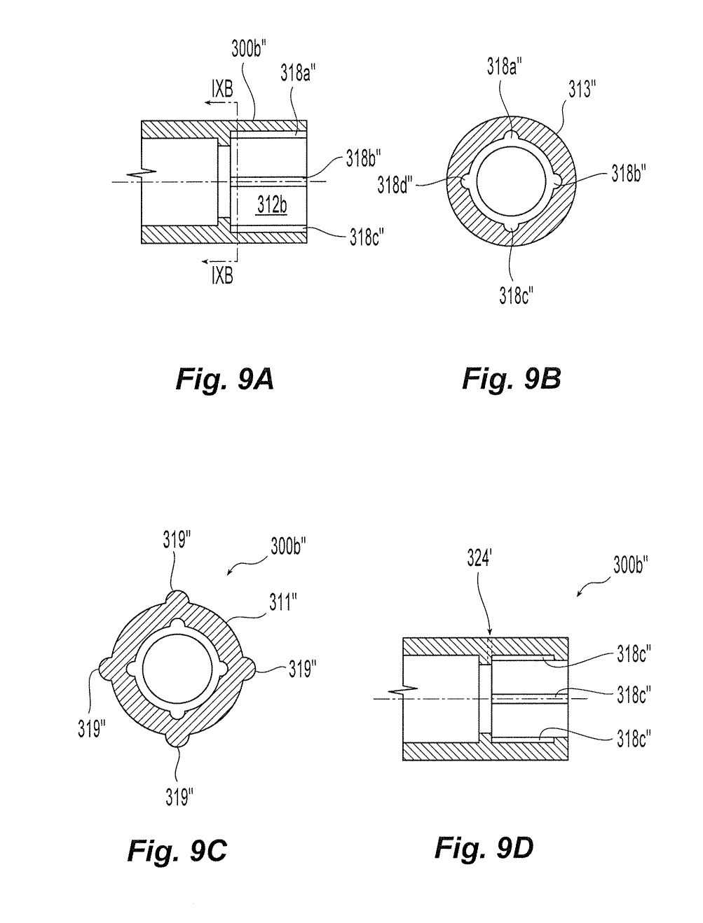

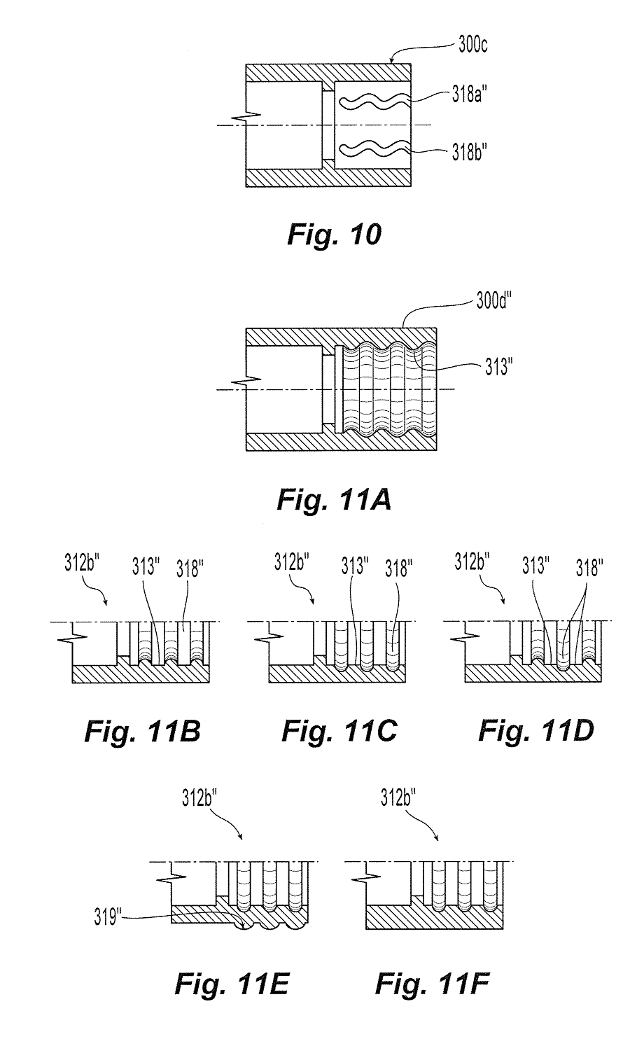

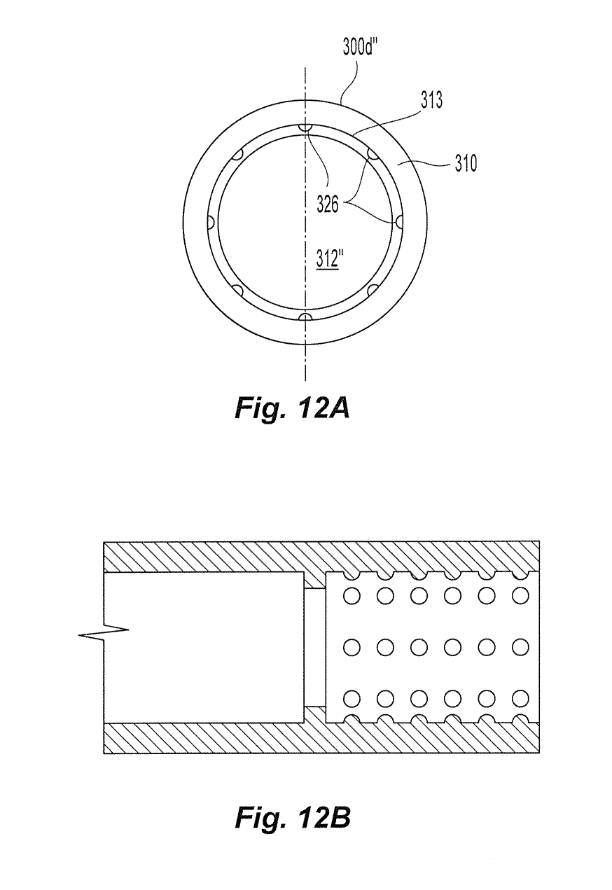

As noted above, the channel 318 may be alternatively configured so long as it provides the coupler in a joint assembly 100 with a fluid path to indicate an improper seal to operating personnel. FIGS. 7A-7D; FIGS. 9A-9D; FIG. 10; FIGS. 11A-11F and FIGS. 12A and 12B show alternative embodiments of the joint 100, fitting 300 and the channel 318. Where the alternate features are illustrated with respect to a single socket of the fitting, it is to be understood that such features are applicable to all of the sockets of the fitting 300. Moreover, where alternate features are shown or described with respect to a single coupler, it is to be understood that such features are applicable to all of the couplers shown and described throughout herein. Shown in FIG. 7A is the fitting 300″ in a joint assembly 100 in which the channel 318″ is located at the gravitational low point in the assembly 100 where a fluid, and particularly a liquid can accumulate. The channel 318″ preferably includes a step transition 317 to form a reservoir for collection of discharged fluid which can enhance the leak indication function.

Another illustrative coupling 300a″ is shown in FIGS. 7B and 7C, the inner surfaces 313″ of sockets 312a″, 312b″ preferably includes a channel 318″ defined by a spiral groove helically extending along the longitudinal length of the fitting 300″. Helical channel 318″ preferably has a rounded profile in the cross-section relative to the length of the channel, but other profiles can be used such as a v-shaped or angled channel, or a square channel. The profile of the channel 318″ defines a depth or height H of the groove relative to the planar inner surfaces 313″, and also defines a passageway that preferably allows one end of the channel 318″ to communicate with the other end of the channel 318″ and/or any other area disposed adjacent to the channel 318″, such as interior passageway 315″. The channel 318″ preferably extends from one or both end faces 310a″, 310b″ of the coupling 300a″ towards the middle of the coupling, and preferably terminates at the abutment or shoulder 314″ disposed at a longitudinally middle position within the coupling 300a″. Alternatively, channel 318″ can extend for only a portion of the length of the sockets 312a″, 312b″ without terminating at the shoulder 314″.

In any one of the preferred fittings 300 described herein, the fluid discharged from the channels 318 is preferably discharged to atmosphere from a channel opening at the end faces 310a, 310b of the fitting 300. Alternatively or in addition to, the channel 318 can include or be configured as a through hole 324 along a medial portion of its outer surface 311 between the end faces 310a, 310b. For example, in another alternative embodiment illustrated in FIG. 7D, the channel 318 can include a portion having one or more through holes 324 passing through the wall of the coupling 300a″ and in communication with the remainder of the channel 318″. The through hole 324, provides fluid entering the channel 318″ from interior passageway 315″ an exit from the coupling 300a″ to provide a direct or indirect indication of a leak in the joint assembly 100. Preferably, the through hole 324 is located at or formed in the shoulder 314″. Alternative, the through hole 324 can be disposed between the shoulder 314″ and an end faces 310a″, 310b″. With the through hole 324 located at such an intermediate position, the remainder of the channel 318″ does not need to extend all the way to the end faces 310a″, 310b″, thereby allowing a relatively shorter channel 318″ that can terminate at the through hole 324.

Referring to the embodiments illustrated in FIGS. 9A-9D, the fitting 300b″ is shown with a particular combination of features of the channel 318 described herein. Specifically shown is the coupling having a plurality of longitudinal channels 318″. Preferably, at least four longitudinally extending channels 318a″, 318b″, 318c″, 318d″ are radially disposed about the inner surface 313″, but any suitable number of channels can be employed. Each of the channels 318″ preferably include a radiused interior surface such that the individual channel 318″ defines a substantially semi-circular channel. Further in the alternative or in addition to, the outer surface 311″ of coupling 300b″ shown at FIG. 9C, can include projections 319″ which are disposed to provide additional support to the wall proximate each of the channels 318″ and/or provide the wall of the fitting with a constant or minimum wall thickness. Preferably, the projections 319″ extend along the outer surface 311″ for a distance equivalent in length to the corresponding channel 318″. Alternatively, the projection 319″can be sized to correspond to only a portion of the channel length 318″, or be disposed on the outer surface 311″ of the coupling 300b″ only proximate to the edge 310″. In the alternative embodiment of the fitting 300b″ illustrated in FIG. 9D, one or more of channels 318a″, 318b″, 318c″, 318d″ are sized to have a length that does not reach the end face of the fitting 310a″. The shorter channels 318″ include a through hole 324 to provide channel communication with the outside environment.

In the illustrative embodiment of a preferred fitting 300c″ in FIG. 10, the channels 318a″, 318b″ formed along the inner surface 313″ of the coupling preferably curve in both a longitudinal and circumferential direction so as to provide a substantially wavy channel 318″. In another illustrative embodiment of the fitting 300d″ of FIG. 11A, the inner surface 313″ has a series of undulations longitudinally disposed, or alternatively disposed in a circumferential direction (not shown) so as to provide a channel 318″ formed about the inner surface 313″ with an undulating channel depth or height H. The undulations are preferably defined by alternating peaks extending radially inward from surface 313 and troughs extending radially outward from the surface 313. The troughs of the channel 318″ are preferably in communication with the end face 310a″, 310b″ and/or include a through hole 324 (not shown) to provide the preferred leak indicator.

In the alternate embodiment of the fitting 300d″ of FIG. 11B, the inner surface 313″ includes a series of peaks extending radially inward from the surface 313″ without radially outwardly extending troughs. The spaces disposed between the peaks preferably define the channel 318″. The height of the peaks locate a pipe segment inserted in the socket 312b at a radial distance from the inner surface 313″ so that spaces between the inner surface 313″ and the outer surface of the pipe segment define the leak path through which fluid can flow and escape in the absence of an appropriate sealant material. The peaks shown in FIG. 11B are shown as continuous circumferential rings spaced longitudinally along the axis of the socket 312b. Referring now to FIGS. 12A and 12B, the internal peak can alternatively be configured as one or more radial inward projections 326. An array of projections 326 are radially disposed about the inner surface 313″. The projections 326 can be specifically configured as dimples 326 preferably semi-spherical in shape and disposed throughout the inner surface of the sockets 312a″, 312b″ to engage the outer surface of a pipe segment disposed therein. Alternative geometries for the radially inward projections 326 may be possible such as, for example, substantially circular cylindrical. Further in the alternative, the projections 326 can be configured as one or more axially elongate projections 326 (not shown) formed with inner surface 313″ to project into the sockets 312a″, 312b″ and engage an outer surface of a pipe segment. Leak paths are preferably formed about or to each side of a projection 326 and over the outer surface of the pipe segment thereby providing one or more channels for detecting improper seal formation. The peaks or projections 326 are preferably dimensioned so as to be small enough that the peaks or projections 326 deform or dissolves in the presence of the preferred sealant material such that a fluid tight seal is formed about the pipe segment.

Shown in FIGS. 11C-11F are further alternate embodiments of the undulating inner surface 313″ forming the channel 318″. Specifically, in FIG. 11C, the inner surface 313″ preferably includes a series of troughs extending radially outward from the surface 313″ without the peaks so as to define the channel 318″. In FIG. 11D, the inner surface 313″ includes an alternating series of peaks extending radially inward from the surface 313″, and troughs extending radially outward from the surface 313″, with a series of areas 56 disposed between the peaks and troughs and aligned with the contour of the inner surface 313. In FIG. 11E, the inner surface 313″ includes the series of troughs, and the exterior surface of the coupling 20 includes a series of projections 319 extending radially outward from the outer surface 311 of the coupling 300d″ to provide a constant or minimum wall thickness to the fitting. In FIG. 11F, instead of projections 319, the thickness of the wall of the fitting 300d″ is increased to the same radial distance illustrated with the outer projections 319 in FIG. 11E.

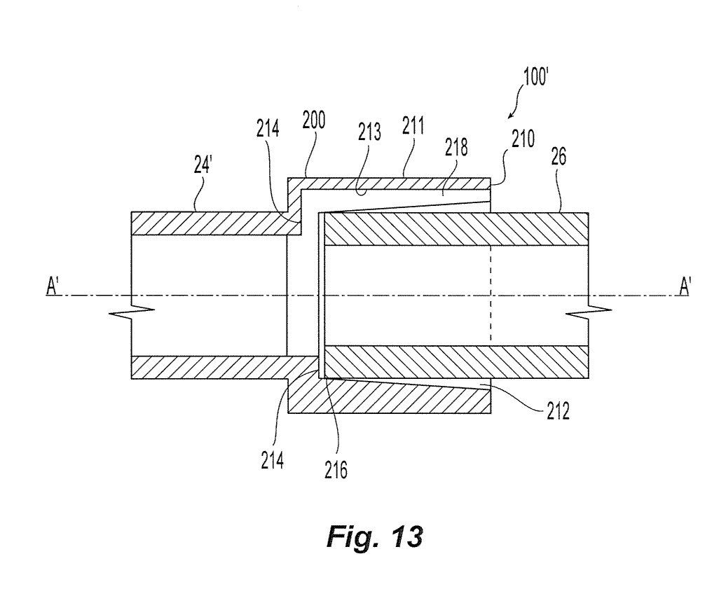

Shown in FIG. 13 is another alternative embodiment of a joint assembly indicated as joint 100′ for incorporation into the system 10. The joint 100′ is formed by a preferred socket-type connection between a pipe segment 26 and another coupler, in which the coupler is preferably configured as an integrated end fitting 200 and a pipe segment 24′. The first pipe segment 24′ and the end fitting 200 are preferably formed as a unitary construction. The end fitting 200 can be formed at an angle relative to the first pipe segment 24′ so as to form an included angle between the first pipe segment 24′ and the second pipe segment 26 such as, for example, 45°, 60°, 90° or other angle. The end fitting 200 can be configured in a manner substantially similar to any one of the sockets 312 of the fittings 300 described above so as to include one or more channels 218 defining a leak path to indicate an improperly sealed joint assembly. The end fitting 200 further preferably includes an outer surface 211 and an inner surface 213 defining a socket 212 in communication with the central passageway of the integral pipe portion 24′. The inner surface 213 further defines a shoulder or ring 214 to further define preferably a step transition between the socket 212 and the central passageway of the first pipe segment 24′. Disposing the second pipe segment 26′ in the socket 212 of the end fitting 200 places the central passageway of the second pipe segment 26′ in communication with the central passageway of the first pipe segment 24′.

The socket 212 and the inner surface 213 are preferably configured to form an interference fit at one or more circumferential points with the outer surface of the second pipe segment 26. For example, the socket 212 is further defined by the preferably tapering inner surface 213 so as to form a substantially circumferential interference fit 216 about the second pipe segment 26. The taper of inner surface 213 can define an angled surface that limits axial progression of a pipe segment 26 to define a space between the end face of the pipe segment 26 and the shoulder 214. Alternatively, the end face of the second pipe segment 26 can engage the shoulder 214 to further limit axial travel of the second pipe segment 26 through the end fitting 210.

As in the case of the preferred fittings 300 described above, the end fitting 200 of pipe segment 24′ further includes one or more slots or channels to define a leak path through which fluid can be conveyed in the absence of an appropriate amount of sealant material. More specifically, the pipe end fitting 200 preferably includes at least one channel 218 to define a leak path over the outer surfaces of the second pipe segment 26 through which a gas or liquid contained in the pipe segments 24′, 26 can escape to atmosphere. The channel 218 can form a discontinuity in the interference fit 216 between the inner surface 213 and the second pipe segments 26. The channel 218 is further in communication with the socket 212 such that fluid flowing from the pipe segments 24′, 26 into the end fitting 210 can escape to atmosphere in the absence of a fluid tight seal. To form the joint 100′ as a fluid tight assembly for service in the piping system 10, a preferably flowable sealant material (not shown), as described above, is applied to the outer surface of the second pipe segment 26 and along the inner surface 213 of the sockets 212. In the fluid tight assembly, the sealant material fills the channels 218 of the fitting 210 so as to prevent the escape of fluid to atmosphere. The channels 218 therefore provides the joint 200 with an indicator to operating personnel of a system 10 an incomplete or failed fluid-tight joint assembly. More specifically, operating personnel using anyone of the previously described detection techniques, is made immediately aware of the lack of adequate or complete absence of sealant material in the socket 212 by the indication of fluid flowing from the channel 218 and/or the failure of the joint 200 to maintain pressure.

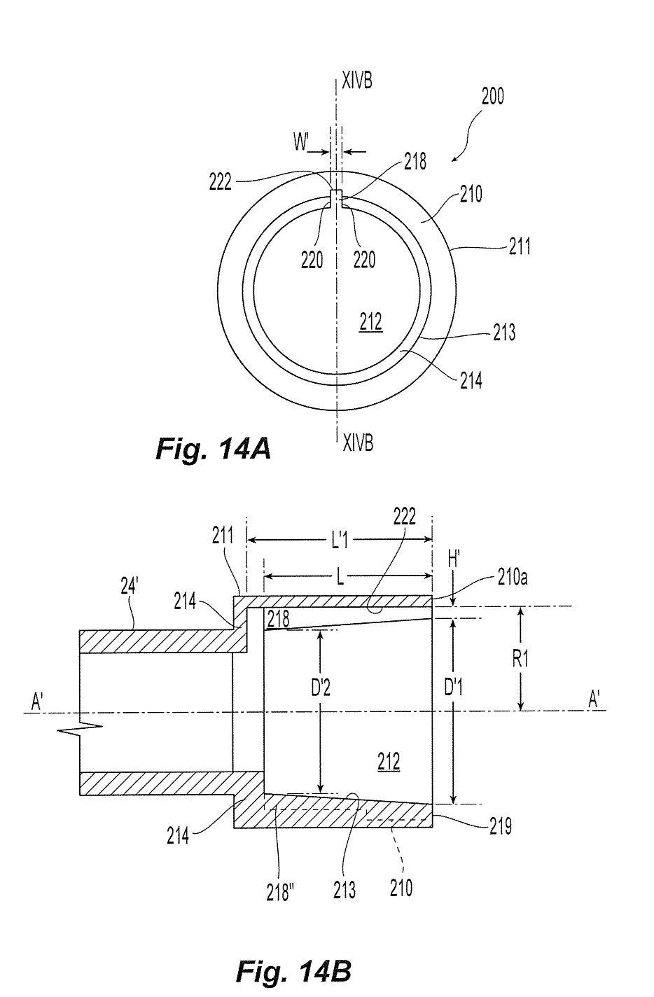

Shown in FIGS. 14A and 14B are respective plan and cross-sectional views of the preferred pipe end fitting 200. The fitting outer surface 211 of the end fitting 200 preferably defines a substantially tubular member having a preferably larger outer diameter than the integrally attached first pipe segment 24′. As previously described, the inner surface 213 defines the socket 212 of the pipe end fitting 200. The inner surface 213 preferably tapers narrowly from the end face 210 of the fitting 200 to the shoulder 214 to define a socket length L′. The taper of the inner surface 213 further preferably defines a first diameter D′1 at the entrance of the socket 212 and a second diameter D′2 at the base or bottom at the socket 212a proximate the shoulder 214. Accordingly, the second diameter D′2 is preferably smaller than the first diameter D′1. The inner surface 213 further preferably defines one or more channels 218. As seen in FIG. 14A, The inner surface more particularly defines the channel 218 by a pair of spaced and substantially preferably parallel sidewalls 220 and an interconnecting interior surface wall 222 extending therebetween. The channel 218 preferably axially extends beyond the length L′ of the socket 212 to define a channel length L′1 greater than the socket length L′. Extending the channel 218 axially beyond the shoulder 214 can further ensure that the channel 218 remains patent and cannot be sealed off solely by the mere engagement between the end face of the second pipe segment 26 and the shoulder 214.

Shown in particular with respect to the socket 212, the inner surface 213 further preferably defines the depth or height H′ of the channel 218. The channel height H preferably deepens from a minimum at the end face 210 of the fitting 200 to a maximum at the shoulder 214. The channel 218 can alternatively or additionally be characterized by a radial distance R′ preferably measured from the central axis A′-A′ to the interconnecting wall surface 222 and in which the radial distance R′ is preferably constant. Alternatively, the interconnecting surface 222 of the channel 218 can parallel the taper of the inner surface 213 such that the radial distance R′ varies accordingly along the length of the channel. Further in the alternative, the interconnecting surface can define a non-planar profile such as, for example, a wave-form, along its axial length.

A channel volume is preferably defined by the channel length, channel height H′ and the channel width W′. The total channel volume of the fitting 200 can be further defined by the number of channels 218 radially disposed about a socket 212. Although only a single channel 218 is shown at the end face 210 of the fitting 200, a plurality of channels 218 may be radially disposed about the central axis A′-A′ of the end fitting 200 to provide multiple indicators to the operating personnel regarding the adequacy of the seal in the joint 200 as described above. The channel volume is configured sufficiently large enough provide a desired leak path so as to prevent any interference fit between the inner surface 213 and the pipe segment 26′ from holding fluid pressure in the joint 100′. Moreover, the channel volume is sufficiently small so as to avoid undesirable pooling of sealant material in the channel 218 proximate the pipe element disposed within the socket 212.

Preferably, the various dimensions of the channel 218, i.e, its depth H′ and width W′ are constant over a range of nominal pipe sizes. The depth H′ and the width W′ can follow the schedule of height and widths in Table 1a at the end face 210a. Alternatively, the channel dimensions can vary with the size of pipe segment to be inserted therein. Accordingly, the fitting 210 can be configured as a reducer in which the socket 212 has smaller inner diameter D′1, D′2 dimensions as compared to the central passageway diameter of the pipe segment 24′ in order to couple a dissimilarly sized pipe segment. Moreover, the socket 212 can be configured for receipt of an adapter to convert the socket-type connection of the socket 212 to a threaded-type connection. Table 2 provides a preferred schedule of socket and channel dimensions, as described above, for a given nominal pipe segment diameter.

TABLE 2

| | | | | | MAXIMUM | |
|---|---|---|---|---|---|---|
| NOMINAL | FIRST | SECOND | MINIMUM | CHANNEL | CHANNEL | CHANNEL |
| PIPE SIZE | DIA. | DIA. | LENGTH | RADIUS | HEIGHT | WIDTH |
| (IN.) | D′1 | D′2 | L′ | R′ | H′ | W′ |
| 0.75 | 1.058 | 1.046 | 0.719 | 0.567 | 0.038 | 0.076 |
| 1 | 1.325 | 1.310 | 0.875 | 0.707 | 0.044 | 0.088 |
| 1.25 | 1.670 | 1.655 | 0.938 | 0.882 | 0.047 | 0.094 |
| 1.5 | 1.912 | 1.894 | 1.375 | 1.023 | 0.067 | 0.134 |
| 2 | 2.387 | 2.369 | 1.500 | 1.267 | 0.073 | 0.146 |
| 2.5 | 2.889 | 2.868 | 1.750 | 1.537 | 0.092 | 0.184 |
| 3 | 3.516 | 3.492 | 1.875 | 1.858 | 0.100 | 0.200 |

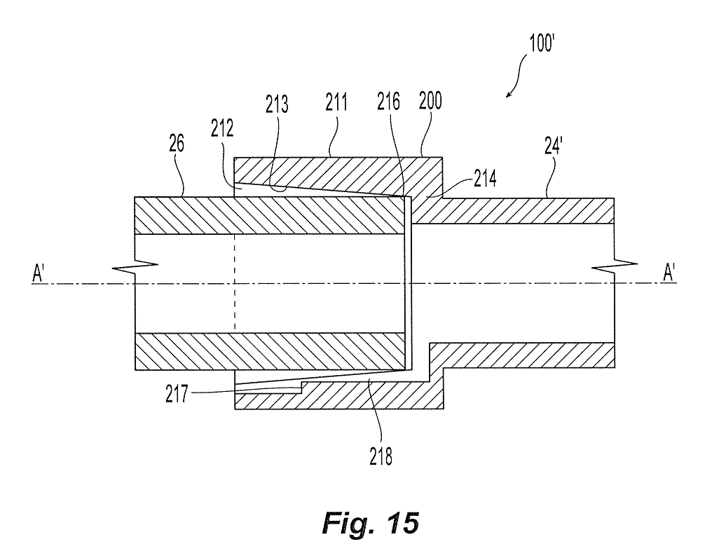

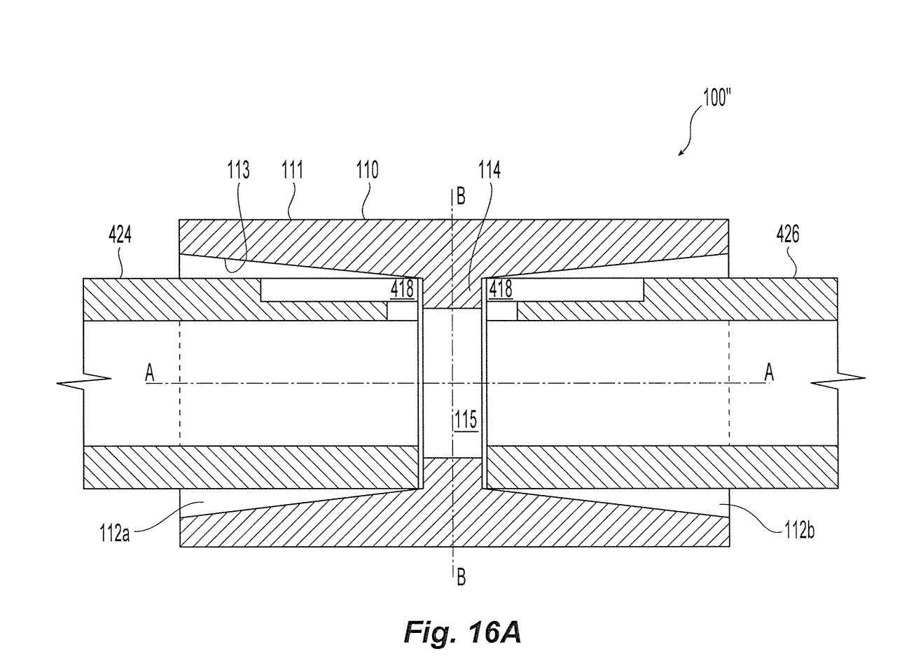

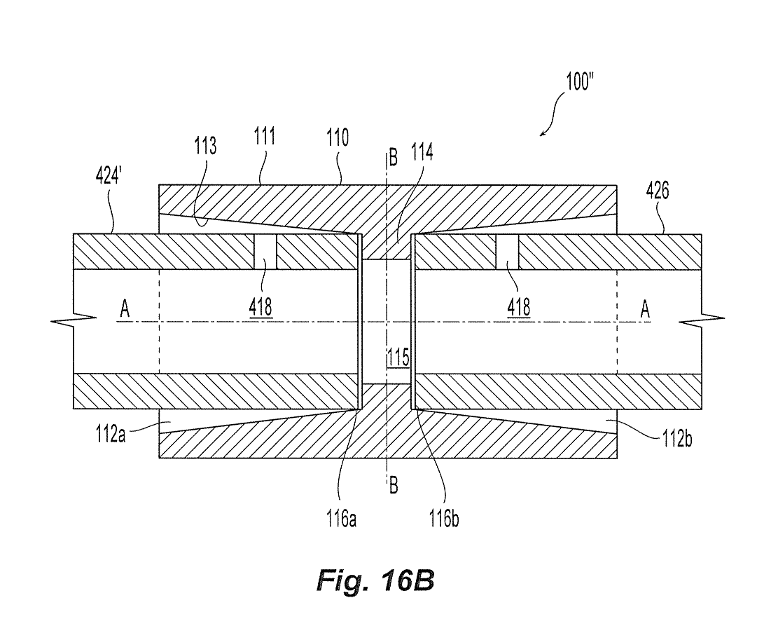

Again, the features of the outer and inner surfaces 211, 213 and channel 218, including the sidewalls 220 and the interconnecting surface 222 of end fitting 200 can be alternatively configured in any manner as described above with respect to the outer and inner surfaces 311, 313, and channel 318, including the sidewalls 320 and interconnecting surface 322 of the fitting 300. Accordingly, the sidewalls 220 are spaced apart to define a channel width W′ and are further preferably substantially vertical. However, the sidewalls 120 can alternatively define an angle with respect to the axis XIVB-XIVB bisecting the channel 218 so as to vary the width W of the channel 218 over the height H. The inner connecting surface 222 is shown as substantially planar, but the surface can be substantially radiused or preferably concave with respect to the interior of the channel 218. Moreover, the corners or bends transitioning surfaces in the channel 218 can be substantially angular as shown or alternatively the corners or bends can be radiused. The channel width W′ can be constant or alternatively vary along the axial length L′, L′1 of the channel 218. In particular, the channel width W′ may taper narrowly from the end face 210a to the shoulder 214. The resultant narrowing channel 218 can create a venturi effect so as to eject any fluid in the channel 218 with some appreciable velocity. Shown in FIG. 15, is an alternate end pipe fitting 200′ in which the channel 218 is preferably configured to be located at the gravitational low point in the assembly 100′ where a fluid, and particularly a liquid can accumulate. The channel 218 can include a step transition 217 to form a reservoir for collection of discharged fluid.

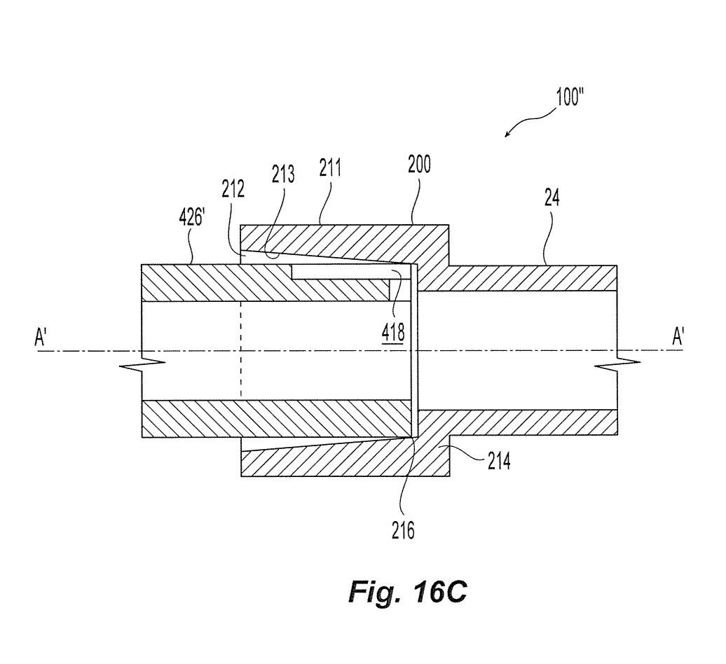

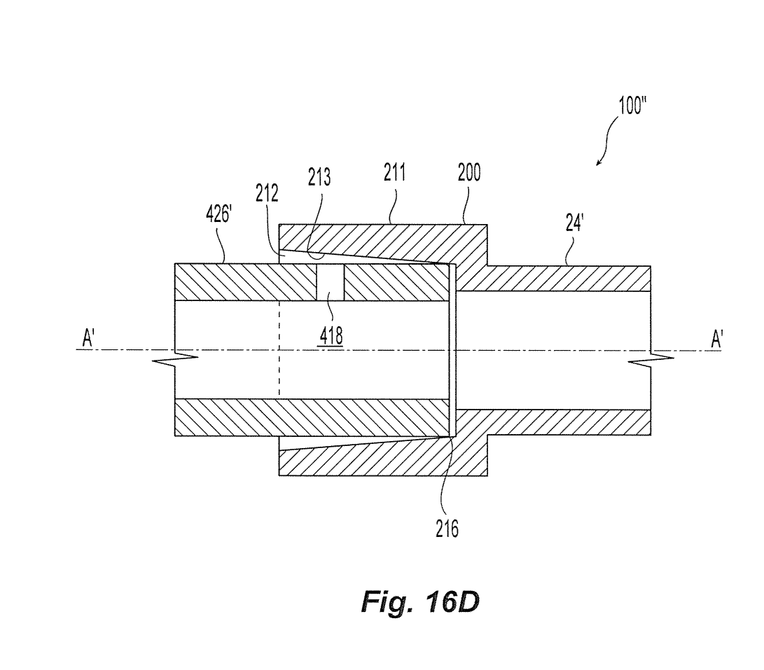

Each of the preferred joint assemblies described above, preferably include a coupler having a channel configured along the inner surface of a socket to form a leak path, in cooperation with a pipe segment, in order to provide operating personnel with an indication of an improperly sealed joint. It should be understood that the same effective leak path can be provided by forming a channel along the outer surface of a tubular wall member such as for example, a pipe segment for cooperation with the inner surface of a socket of a pipe fitting or end fitting. For example, shown in FIG. 16A is the joint 100″ in which the channel 418 is formed and axially extending along the outer surface of the pipe segment 426, 426. More specifically, the wall of the pipe segment 424, 426 is contoured along its outer surface to define the channel along a portion of the outer surface of the pipe segment 424, 426. Where the preferred channel 218 is to be incorporated in the pipe segment and more specifically along the outer surface of the pipe the channel and/or through hole may be formed in the pipe extrusion or forming process. The channel 418 preferably extends from an axially internal portion to the end face of the pipe 424, 426. Alternatively, the channel 418 can terminate axially inward of the pipe end face so that the channel 418 is disposed entirely in the outer diameter surface of pipe 424, 426.

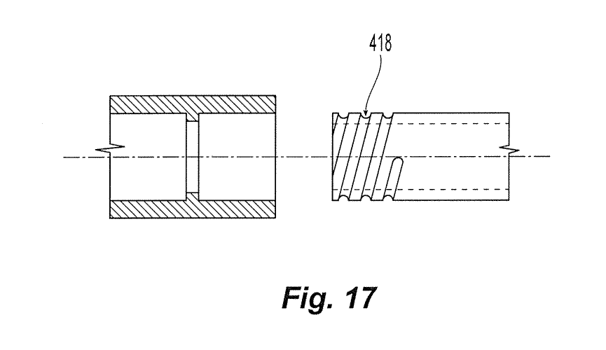

The various configurations of the channel described with respect to the preferred fittings 300 and pipe end fitting 200 are above is substantially equally applicable to a channel 418 formed on the outer surface of the pipe segment 424, 426. Accordingly, the channel 418 of the pipe segment can vary in width height and/or depth along its length. For example, the channel 418 can follow the schedule of depth and width dimensions in Table 1a. Moreover, the channel 418 can be substantially axially linear or alternatively progress axially and circumferentially, as shown for example, in the helical channel 418 of FIG. 17. Further in the alternative, as shown in FIG. 16B, the channel 418 is configured as a radially extending through hole opening in the wall of the pipe segment in communication with the socket 112 and the central passageway of the pipe segment.

The variable configurations of the channel 418 can be formed and disposed about the outer surface of the pipe segment 26′ for insertion in a socket-type pipe end fitting having a circumferentially and substantially continuous inner surface 213 in order to form the desired leak path. FIGS. 16C and 16D, show alternative embodiments of the joint 200 and the channel 218.

Exemplary couplers constructed in accordance with the embodiments having a channel as described above, were incorporated into a test pipe assembly for pneumatic and hydraulic performance testing. The preferred hydraulic and pneumatic tests are configured to determine or evaluate one or more the following performance features of a fitting 300: (i) the time to full evacuation of a predetermined pressure of fluid from the test assembly; (ii) time for maintaining a specified pressure; (iii) the number of cycles over which the fitting is cycled between a low and high pressure; and (iv) the burst pressure of the assembly. The results of the tests can be used to evaluate or verify a channel configuration for use in a working coupler.

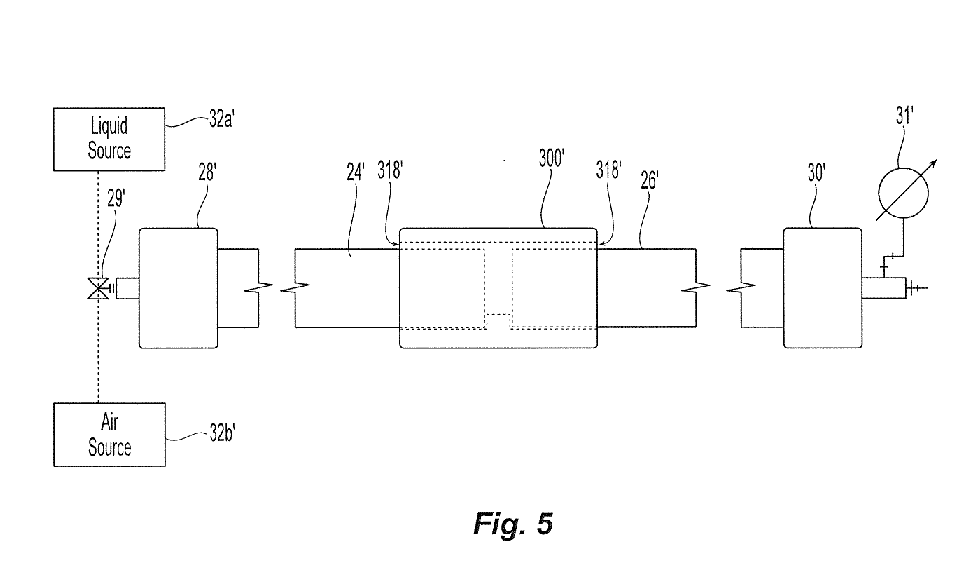

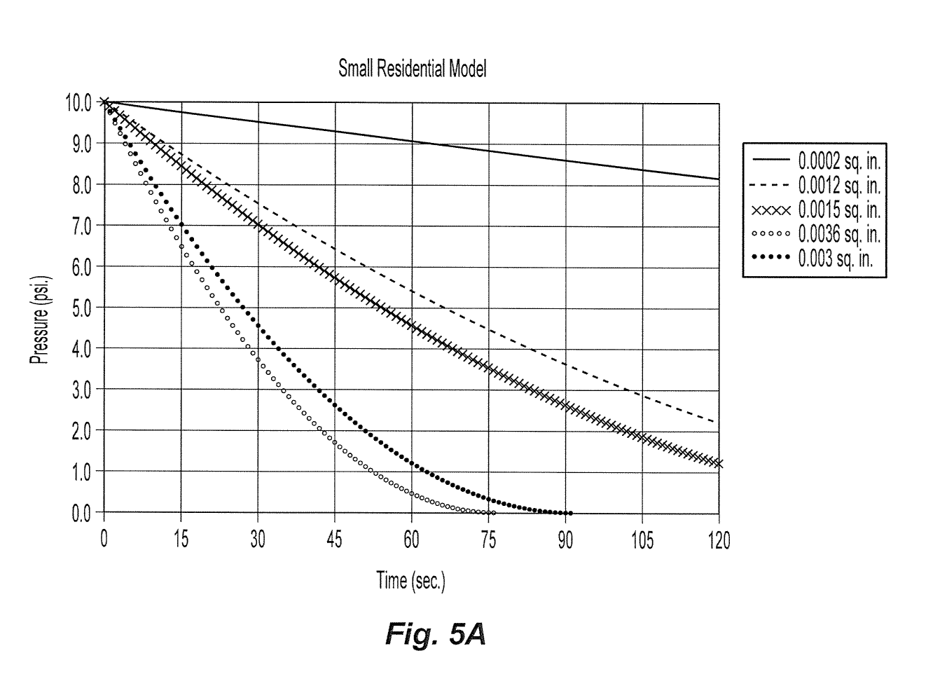

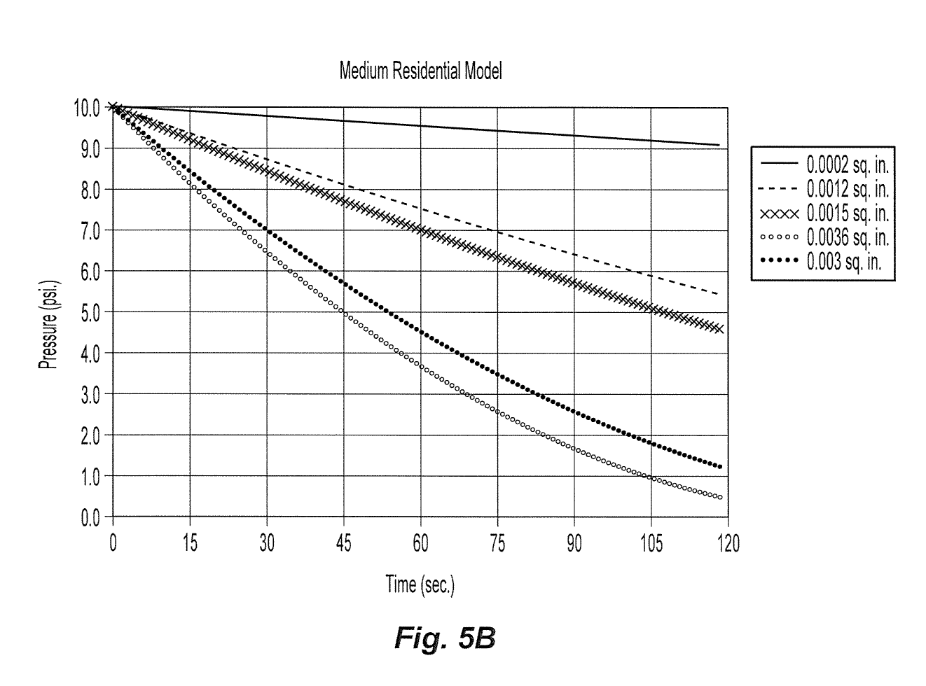

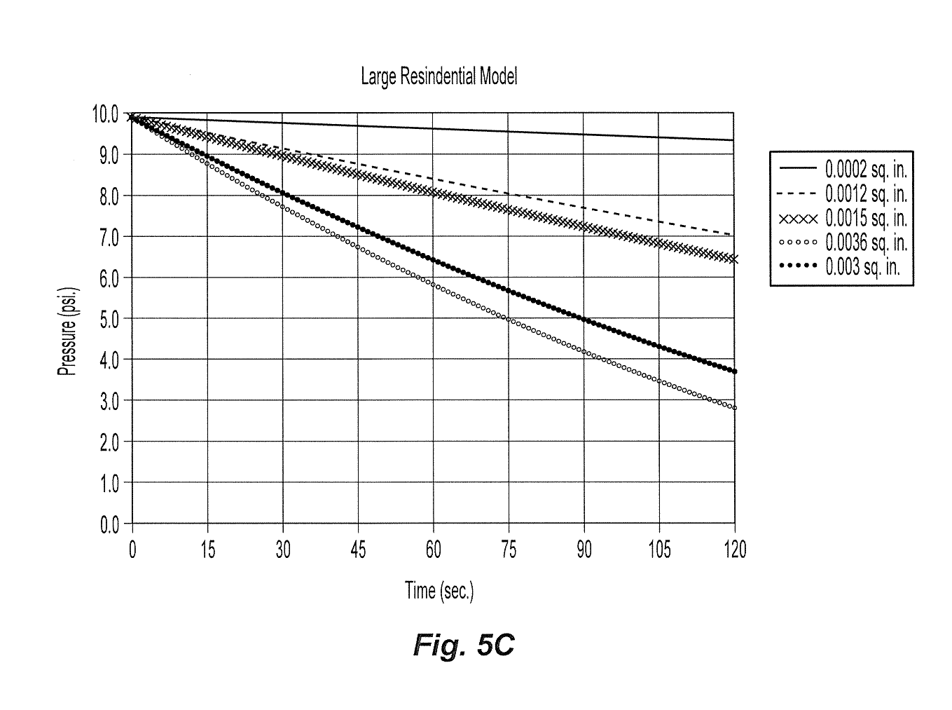

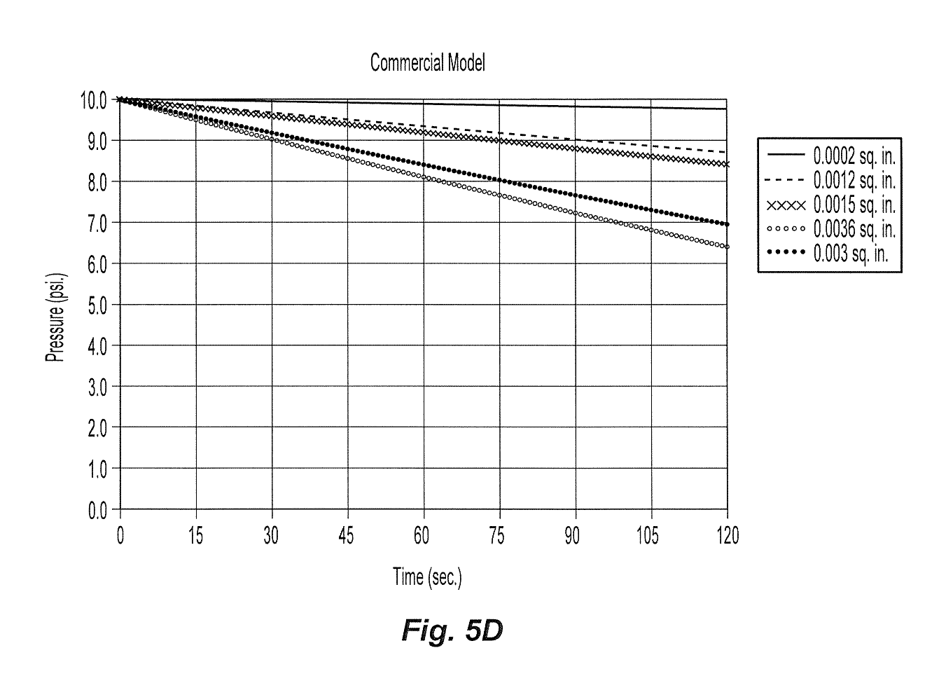

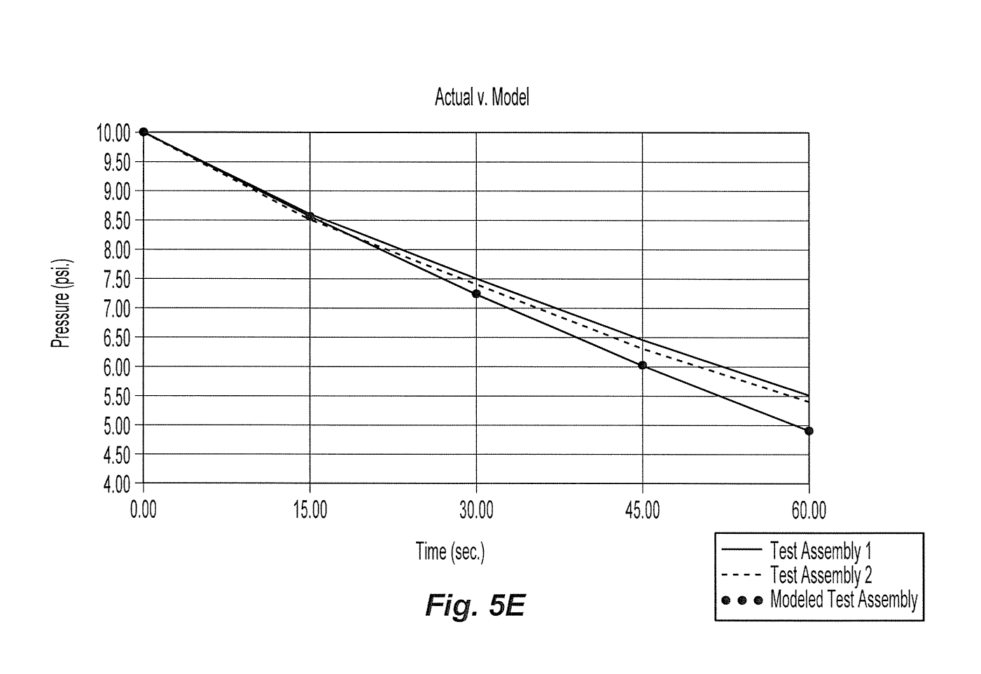

Shown in FIG. 5 is a preferred test assembly for evaluating a preferred coupler. One end of first pipe segment 24′, measuring six inches in length, is inserted in an input socket of a fitting 300, shown as a coupling. Disposed about the opposite end of the first pipe segment 24′ is an end cap with an input adapter 28′ coupled via a flow control device 29′ to a compressed air source for the pneumatic testing and a liquid or water source for the hydraulic testing. At the discharge end of the coupling 300 is one end of a second test pipe segment 26′ also preferably measuring six inches in length. The opposite end of the second test pipe segment 26′ is an end cap 30′ forming a fluid-tight seal at the end of the second test pipe segment 26′. The test fitting 300, all the test pipe segments 24′, 26′ and all the end caps 28′, 30′ cumulatively define the test volume V of the assembly. The test assembly includes a port coupled to a pressure gauge 31′ for monitoring pressure changes in the test assembly over the course of the pneumatic and hydraulic tests. The pressure gauge 31′ is shown as being connected to the end cap 31′. The pressure gauge 31′ can be installed elsewhere along the test assembly provided the gauge can evaluate pressure changes throughout the system. The test assembly of FIG. 5 is shown for evaluation of a coupling 300, and therefore only two test pipes are shown. Where the test fitting 300 has more than two sockets, the test assembly can be provided with a corresponding number of test pipe segments.

The hydraulic and pneumatic tests include: (i) a pneumatic leak test; (ii) a hydraulic leak test; (iii) a first hydrostatic pressure test; (iv) a second hydrostatic pressure test; (v) a hydraulic burst test; and (vi) a hydraulic cycle test. Under each of the pneumatic and hydraulic leak test, the ends of the test pipe segments 24′, 26′ that are respectively inserted into the sockets of the fitting 300′ are each press fit into the sockets without any application of a sealant so as to form the dry fit in order to evaluate the channel 318 as an indicator of an improperly sealed joint. Under the pneumatic leak test, compressed air is introduced into the test assembly through the input end cap 28′, and the input pressure is increased to 10 psi. The time for the complete evacuation of the compressed air from the channels 318 is recorded. Under the hydraulic leak test, water is introduced into the test assembly through the input end cap 28′, and the input pressure is increased to 10 psi. The time for the complete evacuation of the compressed hydraulic fluid from the channels 318 is recorded.

Subsequently, a sealant material, preferably Blazemaster CPVC Cement TFP-500, is applied to each of the ends of the test pipe segments 24′, 26′ and the inner surface 313 of the sockets of the fitting 300 to deform or reconstitute the channels 318 and completely seal the test assembly for use in the hydraulic static, cycle and burst pressure tests. In the first hydraulic static pressure test, the sealed test assembly is pressurized to the preferred working pressure of the test fitting, about 175 psi and the pressure gauge 31′ is observed to see that the test assembly can hold the test pressure constant for at least five minutes. In the second hydrostatic pressure test, the sealed test assembly is pressurized to about 875 psi, and the pressure gauge 31′ is observed to see that the sealed test assembly can hold the test pressure constant for at least five minutes. In the cycle test, water is controlled in and out of the fluid assembly to cycle the pressure in the assembly preferably between about 0 psi and about 350 psi. The pressure is cycled between the two pressures until the earlier of 3,000 cycles or until failure of the assembly. The water pressure is then increased to determine the burst pressure and location of failure in the test assembly.

The above described tests were conducted for a variety of channel 318 profiles defined by the height H and width W of the channel 318 when measured at the end face 310 of the fitting 300 as shown for example, in FIG. 4B. At least five sample fittings were tested for each channel profile. Table 3a summarizes the results of the pneumatic testing. The table respectively shows the pressure at which the time required to exhaust 10 psi from the assembly.

TABLE 3a
“Dry Fit” Time to Evacuation of Pneumatic Pressure

| | | | | | Time to Full Evacuation of | | | | | |
|---|---|---|---|---|---|---|---|---|---|---|
| | Channel | Channel | | Assembly | 10 psi of Air (sec.) | | | | | |
| No. of | Depth—H | Width—W | Area | Volume—V | Samp. | Samp. | Samp. | Samp. | Samp. | Avg. |
| Channels | (in.) | (in.) | (sq.-in.) | (cu-in.) | No. 1 | No. 2 | No. 3 | No. 4 | No. 5 | Time—(sec.) |
| 1 | 0.060 | 0.060 | 0.0036 | 12.02 | 1.00 | 0.69 | 0.78 | 0.81 | 0.65 | 0.79 |
| 1 | 0.015 | 0.100 | 0.0015 | 12.02 | 2.44 | 2.47 | 2.41 | 2.94 | 2.25 | 2.50 |
| 1 | 0.025 | 0.060 | 0.0015 | 12.02 | 1.88 | 2.15 | 2.06 | 2.10 | 2.22 | 2.08 |
| 2 | 0.025 | 0.030 | 0.0015 | 12.02 | 1.22 | 0.82 | 1.34 | 1.25 | 1.25 | 1.18 |
| 3 | 0.025 | 0.020 | 0.0015 | 12.02 | 0.50 | 0.65 | 0.94 | 0.81 | 0.78 | 0.74 |
| 1 | 0.050 | 0.025 | 0.0013 | 12.02 | 2.28 | 2.25 | 2.10 | 2.15 | 2.03 | 2.16 |
| 1 | 0.035 | 0.035 | 0.0012 | 12.02 | 2.56 | 2.31 | 2.50 | 2.68 | 2.40 | 2.49 |
| 1 | 0.015 | 0.080 | 0.0012 | 12.02 | 2.56 | 2.44 | 2.44 | 2.44 | 2.75 | 2.53 |
| 1 | 0.015 | 0.060 | 0.0009 | 12.02 | 2.09 | 2.75 | 2.59 | 2.13 | 2.25 | 2.36 |
| 1 | 0.025 | 0.035 | 0.0009 | 12.02 | 3.60 | 3.84 | 3.25 | 3.22 | 4.22 | 3.63 |
| 1 | 0.035 | 0.025 | 0.0009 | 12.02 | 3.22 | 3.31 | 3.44 | 4.00 | 3.62 | 3.52 |
| 1 | 0.050 | 0.015 | 0.0008 | 12.02 | 3.00 | 3.03 | 3.59 | 3.25 | 2.85 | 3.14 |
| 1 | 0.025 | 0.025 | 0.0006 | 12.02 | 4.34 | 4.40 | 4.59 | 4.06 | 4.25 | 4.33 |
| 1 | 0.005 | 0.100 | 0.0005 | 12.02 | 2.57 | 2.65 | 3.15 | 3.06 | 2.53 | 2.79 |
| 1 | 0.035 | 0.015 | 0.0005 | 12.02 | 1.81 | 1.00 | 1.12 | 1.28 | 1.03 | 1.25 |
| 1 | 0.015 | 0.035 | 0.0005 | 12.02 | 1.68 | 2.18 | 2.13 | 1.50 | 2.09 | 1.92 |
| 1 | 0.005 | 0.080 | 0.0004 | 12.02 | 3.97 | 3.72 | 4.22 | 4.38 | 4.09 | 4.08 |
| 1 | 0.025 | 0.015 | 0.0004 | 12.02 | 4.19 | 3.57 | 2.60 | 3.00 | 3.22 | 3.32 |
| 1 | 0.015 | 0.025 | 0.0004 | 12.02 | 4.10 | 5.60 | 4.47 | 4.84 | 5.25 | 4.85 |
| 1 | 0.005 | 0.060 | 0.0003 | 12.02 | 4.56 | 3.43 | 3.31 | 3.97 | 4.53 | 3.96 |
| 1 | 0.015 | 0.015 | 0.0002 | 12.02 | 4.78 | 7.65 | 4.97 | 5.50 | 6.41 | 5.86 |

According to the summary tables, for the various configurations of channel, the average pressure at which a pneumatic leak is detected ranged from about 0.5 psig to about 1.7 psig Preferably a leak is detected at 1 psig or less from the channel in the test assembly. Detection of a leak at a pressure of 1 psig or less in the test assembly is believed to translate to early identification of a leak in a full piping system having potentially a large number of joint assemblies and hundreds of feet of pipe run. With regard to the pneumatic evacuation time, it is preferred that the test assembly and more specifically the channel of the coupler evacuate the test pressure of 10 psig in approximately 3.5 seconds or less. It is believed that such a preferred evacuation time will facilitate leak detection in a full piping system particularly where the method of detecting a leak employs a single pressure gauge. Fluid pressure which readily leaks from a channel formed in a coupler can translate to a dramatic response at the pressure gauge which can be more easily identified by operating personnel as a leak requiring a sealing repair.

Tables 3b summarize the results of the hydraulic testing. The table shows the time required to exhaust 10 psi from the assembly.

TABLE 3b
“Dry Fit” Time to Evacuation of 10 psi of Hydraulic Pressure

| | | | | | Time to Full Evacuation of | | | | | |
|---|---|---|---|---|---|---|---|---|---|---|
| | Channel | Channel | | Assembly | 10 psi of Water (sec.) | | | | | Avg. |
| No. of | Depth—H | Width—W | Area | Volume—V | Samp. | Samp. | Samp. | Samp. | Samp. | Time |
| Channel | (in.) | (in.) | (sq.-in.) | (cu-in.) | No. 1 | No. 2 | No. 3 | No. 4 | No. 5 | (sec) |
| 1 | 0.060 | 0.060 | 0.0036 | 12.02 | 1.54 | 1.63 | 5.50 | 4.53 | 1.43 | 2.9 |
| 1 | 0.015 | 0.100 | 0.0015 | 12.02 | 7.85 | 8.28 | 9.18 | 8.66 | 9.00 | 8.6 |
| 1 | 0.025 | 0.060 | 0.0015 | 12.02 | 6.34 | 10.22 | 6.54 | 8.06 | 7.03 | 7.6 |
| 2 | 0.025 | 0.030 | 0.0015 | 12.02 | 2.10 | 2.53 | 2.41 | 2.10 | 2.53 | 2.3 |
| 3 | 0.025 | 0.020 | 0.0015 | 12.02 | 1.53 | 1.34 | 1.21 | 1.59 | 1.44 | 1.4 |
| 1 | 0.050 | 0.025 | 0.0013 | 12.02 | 7.97 | 8.00 | 8.10 | 7.18 | 7.81 | 7.8 |
| 1 | 0.035 | 0.035 | 0.0012 | 12.02 | 7.09 | 8.65 | 7.35 | 8.87 | 8.50 | 8.1 |
| 1 | 0.015 | 0.080 | 0.0012 | 12.02 | 4.78 | 5.34 | 6.44 | 7.09 | 6.12 | 6.0 |
| 1 | 0.015 | 0.060 | 0.0009 | 12.02 | 3.69 | 9.15 | 6.22 | 5.91 | 7.19 | 6.4 |
| 1 | 0.025 | 0.035 | 0.0009 | 12.02 | 10.00 | 8.69 | 8.91 | 8.25 | 8.60 | 8.9 |
| 1 | 0.035 | 0.025 | 0.0009 | 12.02 | 8.62 | 9.57 | 8.03 | 10.00 | 9.56 | 9.2 |
| 1 | 0.050 | 0.015 | 0.0008 | 12.02 | 7.81 | 5.72 | 7.90 | 6.93 | 6.09 | 6.9 |
| 1 | 0.025 | 0.025 | 0.0006 | 12.02 | 7.31 | 9.32 | 10.25 | 9.69 | 9.84 | 9.3 |
| 1 | 0.005 | 0.100 | 0.0005 | 12.02 | 5.70 | 9.40 | 10.12 | 6.50 | 9.66 | 8.3 |
| 1 | 0.035 | 0.015 | 0.0005 | 12.02 | 3.22 | 3.15 | 3.91 | 3.94 | 3.06 | 3.5 |
| 1 | 0.015 | 0.035 | 0.0005 | 12.02 | 3.84 | 3.00 | 3.41 | 2.81 | 3.47 | 3.3 |
| 1 | 0.005 | 0.080 | 0.0004 | 12.02 | 8.15 | 7.62 | 10.00 | 8.90 | 8.50 | 8.6 |
| 1 | 0.025 | 0.015 | 0.0004 | 12.02 | 7.81 | 5.41 | 5.68 | 8.34 | 5.97 | 6.6 |
| 1 | 0.015 | 0.025 | 0.0004 | 12.02 | 12.38 | 17.78 | 6.81 | 11.72 | 12.19 | 12.2 |
| 1 | 0.005 | 0.060 | 0.0003 | 12.02 | 8.53 | 7.00 | 6.53 | 15.97 | 10.32 | 9.7 |
| 1 | 0.015 | 0.015 | 0.0002 | 12.02 | 4.09 | 16.19 | 8.47 | 9.43 | 8.91 | 9.4 |

With regard to the pneumatic evacuation time, it is preferred that the test assembly and more specifically the channel of the coupler evacuate the test pressure of 10 psig in under 10 seconds. It is believed that such a preferred evacuation time will facilitate leak detection in a full piping system particularly where the method of hydraulic leak detection employs a single pressure gauge. Fluid pressure which readily leaks from a channel formed in the coupler can translate to a dramatic response at the pressure gauge which can be more easily identified by operating personnel as a leak requiring a sealing repair.

Summarized in Tables 4c and 4d are hydraulic test in which the test assembly was sealed about the coupler using Blazemaster® CPVC TFP-500 Cement. Each of the samples was dynamically tested. More specifically, for each of samples and their given channel configurations, the number of cycles were recorded over which the hydraulic pressure was cycled between zero and three hundred fifty (0-350) PSI. Each of the sealed samples was then subjected to hydraulic testing. Initially, the assembly was pressurized to 175 psi and was observed for five minutes. The assembly was then pressurized to 875 psi and observed for five minutes. In each of the samples, the assembly successfully held the static pressure over the entire test period. The assembly was then pressurized to the point of failure.

TABLE 4c
Sealed Cycle Test Performance

| | | | | | Cycle Hydraulic Test From | | | | | |
|---|---|---|---|---|---|---|---|---|---|---|
| | Channel | Channel | | Assembly | 0-350 PSI (No. Cycles) | | | | | Avg. |
| No. of | Depth—H | Width—W | Area | Volume—V | Samp. | Samp. | Samp. | Samp. | Samp. | No. |
| Channels | (in.) | (in.) | (sq.-in.) | (cu-in.) | No. 1 | No. 2 | No. 3 | No. 4 | No. 5 | Cycles |
| 1 | 0.060 | 0.060 | 0.0036 | 12.02 | 3056 | 3056 | 3056 | 3056 | 3056 | 3056 |
| 1 | 0.015 | 0.100 | 0.0015 | 12.02 | 3006 | 3006 | 3006 | 3006 | 3006 | 3006 |
| 1 | 0.025 | 0.060 | 0.0015 | 12.02 | 3056 | 3056 | 3056 | 3056 | 3056 | 3056 |
| 2 | 0.025 | 0.030 | 0.0015 | 12.02 | 3000 | 3000 | 3000 | 3000 | 3000 | 3000 |
| 3 | 0.025 | 0.020 | 0.0015 | 12.02 | 3000 | 3000 | 3000 | 3000 | 3000 | 3000 |
| 1 | 0.050 | 0.025 | 0.0013 | 12.02 | 3212 | 3212 | 3212 | 3212 | 3212 | 3212 |
| 1 | 0.035 | 0.035 | 0.0012 | 12.02 | 3006 | 3006 | 3006 | 3006 | 3006 | 3006 |
| 1 | 0.015 | 0.060 | 0.0009 | 12.02 | 3004 | 3004 | 3004 | 3004 | 3004 | 3004 |
| 1 | 0.025 | 0.035 | 0.0009 | 12.02 | 3104 | 3104 | 3104 | 3104 | 3104 | 3104 |
| 1 | 0.025 | 0.025 | 0.0006 | 12.02 | 3004 | 3004 | 3004 | 3004 | 3004 | 3004 |
| 1 | 0.005 | 0.100 | 0.0005 | 12.02 | 3212 | 3212 | 3212 | 3212 | 3212 | 3212 |
| 1 | 0.015 | 0.015 | 0.0002 | 12.02 | 3104 | 3104 | 3104 | 3104 | 3104 | 3104 |

TABLE 4d
Sealed Burst Pressure & Failure Point

| | | | | | | | | | | Avg. |
|---|---|---|---|---|---|---|---|---|---|---|
| | Channel | Channel | | Assembly | Burst Pressure (psi) | | | | | Burst |
| No. of | Depth—H | Width—W | Area | Volume—V | Samp. | Samp. | Samp. | Samp. | Samp. | Press. |
| Channels | (in.) | (in.) | (sq.-in.) | (cu-in.) | No. 1 | No. 2 | No. 3 | No. 4 | No. 5 | (psig) |
| 1 | 0.060 | 0.060 | 0.0036 | 12.02 | 1500 | 1490 | 1440 | 1480 | 1460 | 1474 |
| 1 | 0.015 | 0.100 | 0.0015 | 12.02 | 1480 | 1480 | 1490 | 1510 | 1510 | 1494 |
| 1 | 0.025 | 0.060 | 0.0015 | 12.02 | 1520 | 1500 | 1510 | 1520 | 1480 | 1506 |
| 2 | 0.025 | 0.030 | 0.0015 | 12.02 | 1500 | 1520 | 1500 | 1510 | 1500 | 1506 |
| 3 | 0.025 | 0.020 | 0.0015 | 12.02 | 1520 | 1450 | 1480 | 1530 | 1540 | 1504 |
| 1 | 0.050 | 0.025 | 0.0013 | 12.02 | 1440 | 1510 | 1500 | 1490 | 1440 | 1476 |
| 1 | 0.035 | 0.035 | 0.0012 | 12.02 | 1460 | 1360 | 1500 | 1510 | 1510 | 1468 |
| 1 | 0.015 | 0.060 | 0.0009 | 12.02 | 1470 | 1490 | 1500 | 1510 | 1520 | 1498 |
| 1 | 0.025 | 0.035 | 0.0009 | 12.02 | 1500 | 1480 | 1450 | 1480 | 1510 | 1484 |
| 1 | 0.025 | 0.025 | 0.0006 | 12.02 | 1440 | X | 1500 | 1400 | 1475 | 1454 |
| 1 | 0.005 | 0.100 | 0.0005 | 12.02 | 1500 | 1000 | 1480 | 1480 | 1490 | 1390 |
| 1 | 0.015 | 0.015 | 0.0002 | 12.02 | 1470 | 1490 | 1500 | 1510 | 1520 | 1498 |

X—No data available

Each of the sealed performance test assemblies successfully cycled over the 0-350 psi range on average for 3,000 cycles or more. With regard to the burst and failure point test, each of the assemblies failed on an average from about 1400 psig to about 1500 psig Notably, the assembly splits at the pipe and not the coupler. Accordingly, the sealed performance tests demonstrate that for the channel configurations listed, a coupler having such an included channel can be sealed, performs successfully and does not have reduced performance as compared to coupler without a channel. As a matter of comparison, samples of standard nominal one inch couplings (no channel) were subject to similar sealed performance tests and the standard couplings were shown to have an average cycle count of 3,118 cycles over the 0-350 psi pressure range. The test assemblies using the standard fittings were also shown to have an average burst pressure of about 1480 psig with the assembly splitting at the pipe and not the coupling.

To further demonstrate that the inclusion of a channel in a coupler does not degrade performance, an alternate sealant material was utilized in the test assembly. Three channel configurations were tested in the pneumatic and hydraulic tests described above. For the sealed performance test, the assembly is sealed about the coupler using an epoxy, preferably epoxy product 10-3216 from EPDXIES ETC. . . . located in Cranston, R.I. Results of the test are summarized below in Tables 5a-5b and 6a-6b.

TABLE 5a
“Dry Fit” Time to Evacuation of Pneumatic Pressure

| | | | | | Time to Full Evacuation of | | | | | |
|---|---|---|---|---|---|---|---|---|---|---|
| | Channel | Channel | | Assembly | 10 psi of Air (sec.) | | | | | |
| No. of | Depth—H | Width—W | Area | Volume—V | Samp. | Samp. | Samp. | Samp. | Samp. | Avg. |
| Channels | (in.) | (in.) | (sq.-in.) | (cu-in.) | No. 1 | No. 2 | No. 3 | No. 4 | No. 5 | Time—(sec.) |
| 1 | 0.060 | 0.060 | 0.0036 | 12.02 | 0.65 | 0.72 | 0.72 | 0.88 | 0.81 | 0.76 |
| 1 | 0.025 | 0.060 | 0.0015 | 12.02 | 1.97 | 1.85 | 1.69 | 2.03 | 1.72 | 1.85 |
| 1 | 0.015 | 0.015 | 0.0002 | 12.02 | 2.18 | 2.16 | 1.87 | 1.78 | 1.94 | 1.99 |

TABLE 5b
“Dry Fit” Time to Evacuation of 10 psi of Hydraulic Pressure

| | | | | | Time to Full Evacuation of | | | | | |
|---|---|---|---|---|---|---|---|---|---|---|
| | Channel | Channel | | Assembly | 10 psi of Water (sec.) | | | | | Avg. |
| No. of | Depth—H | Width—W | Area | Volume—V | Samp. | Samp. | Samp. | Samp. | Samp. | Time |
| Channels | (in.) | (in.) | (sq.-in.) | (cu-in.) | No. 1 | No. 2 | No. 3 | No. 4 | No. 5 | (sec) |
| 1 | 0.060 | 0.060 | 0.0036 | 12.02 | 1.91 | 2.41 | 3.47 | 4.6 | 2.28 | 2.93 |
| 1 | 0.025 | 0.060 | 0.0015 | 12.02 | 6 | 8.34 | 7.47 | 7.12 | 8.75 | 7.54 |
| 1 | 0.015 | 0.015 | 0.0002 | 12.02 | 4.34 | 4.38 | 3.9 | 5.88 | 4.72 | 4.64 |

TABLE 6a
Sealed Cycle Test Performance

| | | | | | Cycle Hydraulic Test From | | | | | |
|---|---|---|---|---|---|---|---|---|---|---|
| | Channel | Channel | | Assembly | 0-350 PSI (No. Cycles) | | | | | Avg. |
| No. of | Depth—H | Width—W | Area | Volume—V | Samp. | Samp. | Samp. | Samp. | Samp. | No. |
| Channels | (in.) | (in.) | (sq.-in.) | (cu-in.) | No. 1 | No. 2 | No. 3 | No. 4 | No. 5 | Cycles |
| 1 | 0.060 | 0.060 | 0.0036 | 12.02 | 3308 | 3308 | 3308 | 3308 | 3308 | 3308 |
| 1 | 0.025 | 0.060 | 0.0015 | 12.02 | 3214 | 3214 | 3214 | 3214 | 3214 | 3214 |
| 1 | 0.015 | 0.015 | 0.0002 | 12.02 | 3214 | 3214 | 3214 | 3214 | 3214 | 3214 |

TABLE 6b
Sealed Burst Pressure & Failure Point

| | | | | | | | | | | Avg. |
|---|---|---|---|---|---|---|---|---|---|---|
| | Channel | Channel | | Assembly | Burst Pressure (psi) | | | | | Burst |
| No. of | Depth—H | Width—W | Area | Volume—V | Samp. | Samp. | Samp. | Samp. | Samp. | Press. |
| Channels | (in.) | (in.) | (sq.-in.) | (cu-in.) | No. 1 | No. 2 | No. 3 | No. 4 | No. 5 | (psig) |
| 1 | 0.060 | 0.060 | 0.0036 | 12.02 | 1480 | 1480 | 1440 | 1500 | 1500 | 1480 |
| 1 | 0.025 | 0.060 | 0.0015 | 12.02 | 1500 | 1500 | 1500 | 1500 | 1500 | 1500 |
| 1 | 0.015 | 0.015 | 0.0002 | 12.02 | 1490 | 1500 | 1500 | 1500 | 1510 | 1500 |

With regard to the burst and failure point test, each of the assemblies failed on an average at about 1500 psig Notably, the assembly splits at the pipe and not the coupler.

To further demonstrate that the preferred coupler can be constructed from alternate materials, a copper test assembly was constructed from a nominal one inch coupling and twelve inch copper pipe. Two channel configurations were tested in the pneumatic and hydraulic tests described above. Results of the tests are summarized below in Tables 7a-7d.

TABLE 7a
“Dry Fit” Time to Evacuation of Pneumatic Pressure

| | | | | | Time to Full Evacuation of | | | | | |
|---|---|---|---|---|---|---|---|---|---|---|
| | Channel | Channel | | Assembly | 10 psi of Air (sec.) | | | | | |
| No. of | Depth—H | Width—W | Area | Volume—V | Samp. | Samp. | Samp. | Samp. | Samp. | Avg. |
| Channels | (in.) | (in.) | (sq.-in.) | (cu-in.) | No. 1 | No. 2 | No. 3 | No. 4 | No. 5 | Time—(sec.) |
| 1 | 0.025 | 0.060 | 0.0015 | 11.82 | 1.34 | 2.06 | 2.47 | 1.90 | 1.75 | 1.90 |
| 1 | 0.015 | 0.045 | 0.0007 | 11.82 | 1.69 | 2.78 | 2.41 | 2.66 | 1.75 | 2.26 |

TABLE 7b
“Dry Fit” Time to Evacuation of 10 psi of Hydraulic Pressure

| | | | | | Time to Full Evacuation of | | | | | |
|---|---|---|---|---|---|---|---|---|---|---|
| | Channel | Channel | | Assembly | 10 psi of Water (sec.) | | | | | Avg. |
| No. of | Depth—H | Width—W | Area | Volume—V | Samp. | Samp. | Samp. | Samp. | Samp. | Time |
| Channels | (in.) | (in.) | (sq.-in.) | (cu-in.) | No. 1 | No. 2 | No. 3 | No. 4 | No. 5 | (sec) |
| 1 | 0.025 | 0.060 | 0.0015 | 11.82 | 2.87 | 4.81 | 5.87 | 2.53 | 2.18 | 3.65 |
| 1 | 0.015 | 0.045 | 0.0007 | 11.82 | 2.6 | 6.22 | 6.41 | 5.13 | 6.85 | 5.44 |

The copper test assemblies were soldered to form a fluid tight seal about the test coupling. In the sealed hydraulic test, the assembly was pressurized to 200 psi and was observed for five minutes. In the sealed hydraulic test, the assembly was pressurized to 1000 psi and observed for five minutes. In each of the samples, the assembly successfully held the static pressure over the entire test period. Each of the samples was further dynamically tested. More specifically, for each of samples and their given channel configurations, the number of cycles were recorded over which the hydraulic pressure was cycled between zero and 400 (0-400) PSI. Results of the cycle test are summarized in Table 8a. Each sample assembly was then pressurized to 3000 psi, and all but one of the samples maintained a fluid tight seal and showed no sign of failure. The one sample that did not pass the 3000 psi test, failed to do so because of a problem with the solder and not due to the presence of a channel in the test fitting.

TABLE 8a
Sealed Cycle Test Performance

| | | | | | Cycle Hydraulic Test From | | | | | |
|---|---|---|---|---|---|---|---|---|---|---|
| | Channel | Channel | | Assembly | 0-400 PSI (No. Cycles) | | | | | Avg. |
| No. of | Depth—H | Width—W | Area | Volume—V | Samp. | Samp. | Samp. | Samp. | Samp. | No. |
| Channels | (in.) | (in.) | (sq.-in.) | (cu-in.) | No. 1 | No. 2 | No. 3 | No. 4 | No. 5 | Cycles |
| 1 | 0.025 | 0.060 | 0.0015 | 11.82 | 3142 | 3142 | 3142 | 3142 | 3142 | 3142 |
| 1 | 0.015 | 0.045 | 0.0007 | 11.82 | 3142 | X* | 3142 | 3142 | 3142 | 3142 |

*Failed Solder Joint - Not tested

To demonstrate that a channel of a given configuration can be employed in varying nominal size pipe, a test assembly was constructed from a nominal three inch CPVC coupling and one foot of nominal three inch pipe. Two channel configurations were tested in the pneumatic and hydraulic tests described above. Results of the tests are summarized below in Tables 9a-9d.

TABLE 9a
“Dry Fit” Time to Evacuation of Pneumatic Pressure

| | | | | | Time to Full Evacuation of | | | | | |
|---|---|---|---|---|---|---|---|---|---|---|
| | Channel | Channel | | Assembly | 10 psi of Air (sec.) | | | | | |
| No. of | Depth—H | Width—W | Area | Volume—V | Samp. | Samp. | Samp. | Samp. | Samp. | Avg. |
| Channels | (in.) | (in.) | (sq.-in.) | (cu-in.) | No. 1 | No. 2 | No. 3 | No. 4 | No. 5 | Time—(sec.) |
| 1 | 0.025 | 0.060 | 0.0015 | 108.6 | 4.90 | 3.62 | 5.37 | 6.06 | 4.15 | 4.82 |
| 1 | 0.060 | 0.060 | 0.0036 | 108.6 | 1.50 | 1.25 | 1.78 | 1.72 | 1.37 | 1.52 |

TABLE 9b
“Dry Fit” Time to Evacuation of 10 psi of Hydraulic Pressure

| | | | | | Time to Full Evacuation of | | | | | |
|---|---|---|---|---|---|---|---|---|---|---|
| | Channel | Channel | | Assembly | 10 psi of Water (sec.) | | | | | Avg. |
| No. of | Depth—H | Width—W | Area | Volume—V | Samp. | Samp. | Samp. | Samp. | Samp. | Time |
| Channels | (in.) | (in.) | (sq.-in.) | (cu-in.) | No. 1 | No. 2 | No. 3 | No. 4 | No. 5 | (sec) |
| 1 | 0.025 | 0.060 | 0.0015 | 108.6 | 50.54 | 40.34 | 61.75 | 66.16 | 41.19 | 52.00 |
| 1 | 0.060 | 0.060 | 0.0036 | 108.6 | 25.03 | 25.03 | 42.53 | 37.28 | 56.60 | 37.29 |

TABLE 9c
Sealed Cycle Test Performance

| | | | | | Cycle Hydraulic Test From | | | | | |
|---|---|---|---|---|---|---|---|---|---|---|
| | Channel | Channel | | Assembly | 0-400 PSI (No. Cycles) | | | | | Avg. |
| No. of | Depth—H | Width—W | Area | Volume—V | Samp. | Samp. | Samp. | Samp. | Samp. | No. |
| Channels | (in.) | (in.) | (sq.-in.) | (cu-in.) | No. 1 | No. 2 | No. 3 | No. 4 | No. 5 | Cycles |
| 1 | 0.025 | 0.060 | 0.0015 | 108.6 | 3218 | X | X | 3218 | X | 3218 |
| 1 | 0.060 | 0.060 | 0.0036 | 108.6 | 3218 | X | 3218 | X | X | 3218 |

X—Data Not Available

TABLE 9d
Sealed Burst Pressure & Failure Point

| | | | | | | | | | | Avg. |
|---|---|---|---|---|---|---|---|---|---|---|
| | Channel | Channel | | Assembly | Burst Pressure (psi) | | | | | Burst |
| No. of | Depth—H | Width—W | Area | Volume—V | Samp. | Samp. | Samp. | Samp. | Samp. | Press. |
| Channels | (in.) | (in.) | (sq.-in.) | (cu-in.) | No. 1 | No. 2 | No. 3 | No. 4 | No. 5 | (psig) |
| 1 | 0.025 | 0.060 | 0.0015 | 108.6 | 1200 | X | X | 1300 | X | 1250 |
| 1 | 0.060 | 0.060 | 0.0036 | 108.6 | 840 | X | 1080 | X | X | 960 |

X—Data Not Available

According to the test results, at least two channel configuration that were suitable for use in the nominal one inch coupling provided equally satisfactory performance in the nominal three inch couplings. In particular, the sealed performance tests again demonstrate that the channels in the nominal three inch coupling do not reduce the performance of the coupling. Specifically, the average cycles and burst pressures were as expected for a nominal three inch fitting. In the hydrostatic pressure test, all the tested samples held the 175 psi of water pressure for five minutes, and only one of the four test samples failed at the 875 psi hydrostatic test. Notably in the burst pressure tests, the coupling failed along its medial circumference which indicates that the failure was independent of the channels.

To further evaluate the test data and the preferred test assemblies and couplers, a series of fluid dynamic models were developed to compare the test data to a calculated performance. More specifically, each model was constructed to characterize a given coupler and more specifically characterize a fitting having a given channel configuration in a preferred test assembly. The model was then further expanded to evaluate the coupler when installed in a residential occupancy fire protection piping assembly and a commercial occupancy fire protection piping system. Each model characterizes the coupler installed in a preferred piping assembly having a volume that is typical for the given pipe assembly. In each model, the assembly is simulated as being pressurized with an initial pressure, preferably 10 psi of air. With the modeled piping assembly at an initial pressure, the assembly is modeled at an initial time t₀=0 sec, having an open orifice that approximates the leak path formed by the channel in the modeled fitting about a pipe segment. The model then simulates the evacuation of fluid, in this case, air from the modeled channel by calculating for each unit of time, the pressure remaining in the piping system.

The model calculates the pressure at each unit of time by solving a set of equations that relate the system pressure to the mass flow rate of the gas exiting through the coupler channel. In a piping assembly having a coupler with a preferred channel, the mass flow rate of the gas through the open channel is determined by

$$\begin{matrix}{\dot{m}}_{a} = {A}_{a} {{P}_{a} [ \frac{γ}{{RT}_{a}} {( \frac{2}{γ + 1} )}^{\frac{γ + 1}{γ - 1}} ]}^{1 / 2} \\ for {P}_{∞} / {P}_{a} < {( γ + 1 / 2 )}^{γ / γ - 1} & ( Eq . 1 ) \\ or & \\ {\dot{m}}_{a} = {A}_{a} {P}_{a} {\{ \frac{2 γ}{{RT}_{a} ( γ - 1 )} [ {( \frac{{P}_{∞}}{{P}_{a}} )}^{\frac{2}{γ}} - {( \frac{{P}_{∞}}{{P}_{a}} )}^{\frac{γ + 1}{γ}} ] \}}^{1 / 2} \\ for {P}_{∞} / {P}_{a} \geq {( γ + 1 / 2 )}^{γ / γ - 1} & ( Eq . 2 )\end{matrix}$$

where \dot{m}ₐ is the mass flow rate,
Pₐ is the initial system pressure and P_{∞} is the atmospheric pressure,
Tₐ is the gas temperature in the system,
Aₐ is the discharge area defined by the channel depth and width,
γ the ratio of specific heat at constant pressure versus the specific heat at constant pressure at constant volume, γ=1.4 for 2-atomic gases and
R is the gas constant.

To relate the change in pressure, volume and temperature to the mass flow rate of the gas, the following equation is used:

$$\frac{d}{d t} [ \frac{{P}_{a} {V}_{a}}{{RT}_{a}} ] = - {\dot{m}}_{a} \qquad ( Eq . 3 )$$

where Vₐ is the total volume of the piping assembly.

For a pipe assembly under pressure having a coupler with an open channel forming a leak path, the internal gas pressure change can be characterized by

$$\frac{d {P}_{a}}{d t} = - \frac{{\dot{m}}_{a} {RT}_{a}^{0}}{{V}_{a}} {{γ}_{1} ( {P}_{a} / {P}_{a}^{0} )}^{\frac{{γ}_{1} - 1}{{γ}_{1}}} , \qquad ( Eq . 4 )$$

where Pₐ^{o} and Tₐ^{o}=gas pressure and temperature respectively at the moment of sprinkler opening;
γ₁=γ for isentropic gas movement in the piping system,
γ₁=1 for isothermal gas movement.

In Eq. 1 and Eq. 2:

$${T}_{a} = {{T}_{a}^{0} ( {P}_{a} / {P}_{a}^{0} )}^{\frac{{γ}_{1} - 1}{{γ}_{1}}} , \qquad ( Eq . 5 )$$

where Pₐ^{o} and Tₐ^{o}—are the initial pressure and temperature of the gas in the test assembly. To determine the air pressure in the system as function of time, Equation 4 can be integrated by a standard numerical integration scheme.

The above equations were used to generate the pipe assembly models and solve for the pressure in a modeled system at each interval of time. Based on the equations above, the input variables for the model are: (i) total system volume Vₐ, (ii) the initial system pressure Pₐ^{o}; (iii) the initial temperature of the air in the system Tₐ^{o}; and (iv) the orifice size that corresponds to the channel cross-sectional area. The system volume was based upon an assumed number of linear feet for a given nominal size pipe and an assumed number of correspondingly nominally sized fittings. For a conservative estimate, the calculated system volume Vₐ was increased an additional four percent. For each modeled system, the initial system pressure was set at 10 psi, and the initial gas temperature was assumed to be approximately ambient temperature, sixty-eight degrees Fahrenheit (68° F.). Additional assumptions were made for each model, including the assumption that friction losses through the piping could be ignored and that the leak path formed by the channel is assumed to be free of any obstruction or debris. In addition, it is assumed that at the initial start of evacuation, i.e., time=0 sec., the evacuation immediately begins.

A first model was generated which corresponded to the test assembly for a preferred nominal one inch fitting, as described above. The modeled fitting included a 0.015 in.×0.015 in. channel, and with one foot of nominal one inch pipe, the assembly was determined to have a system volume Vₐ of about 0.228 gallons (gal.). The initial system air pressure Pₐ^{o} was set to 10 psi and the initial system air temperature Tₐ^{o} was assumed to be 68° F. According to the model results, the 10 psi of system pressure was evacuated within five seconds. The model further assumes the leak path in a joint assembly is at a minimum by being defined exclusively through the channel of the modeled fitting. Therefore the model does not account for the additional leak path volume, in addition to the channel, defined by the gaps between the inner surface of the fitting and the outer surface of the pipe in an actual test assembly.

To further demonstrate the accuracy of the model, two sealed fluid-tight test assemblies were constructed with the ends of the pipe assemblies each having an end cap with a 0.063 inch diameter hole drilled into it. The hole presents the exclusive point of discharge in each of the test assemblies. The test assemblies were then subjected to the pneumatic evacuation tests described above. Plots of the pneumatic profiles for the two test assemblies are shown in FIG. 5E. The test assembly was then modeled and its pneumatic evacuation profile plotted. The modeled profile closely approximates the performance of the actual test assemblies.

The model was expanded to evaluate the evacuation performance of the preferred coupler and channel in a larger piping system. Accordingly, a second model was generated to approximate the preferred coupler in a fire protection system for a small residential occupancy. The second model assumes that the system is constructed using about 225 feet of one inch piping, twenty-five 90-Degree elbows and twenty-five Tees to define a system volume Vₐ, including the four percent increase, of about 11.544 gal. The initial system air pressure Pₐ^{o} was set to 10 psi and the initial system air temperature Tₐ^{o} was assumed to be 68° F. The time dependent pressure profiles were determined for seven different channel configurations in a nominal one inch fitting, which define five different total channel cross-sectional areas measured at the end face of the fitting: (i) 0.0002 sq. in.; (ii) 0.0012 sq. in.; (iii) 0.0015 sq. in.; (iv) 0.0030 sq. in.; (v) 0.0036 sq. in. The various channel configurations area summarized in Table 10 below.

TABLE 10

| No. of | No. of | Channel | Channel | |
|---|---|---|---|---|
| Channels | Sockets | Depth - H (in.) | Width - W (in.) | Area (sq.-in.) |
| 1 | 1 | 0.015 | 0.015 | 0.0002 |
| 1 | 1 | 0.035 | 0.035 | 0.0012 |
| 1 | 1 | 0.025 | 0.060 | 0.0015 |
| 1 | 1 | 0.015 | 0.100 | 0.0015 |
| 2 | 1 & 2 | 0.025 | 0.030 | 0.0015 |
| 2 | 1 & 2 | 0.025 | 0.060 | 0.0030 |
| 1 | 1 | 0.060 | 0.060 | 0.0036 |

Because the model is dependent upon the total cross-sectional area of a channel opening at the end face of the modeled fitting, various dry fit improper seals are presented by a given pressure evacuation profile. For a single channel scenario, the model characterizes only one socket in the coupling that is improperly sealed. For a two channel scenario, the model characterizes: (i) a single channel extending the length of the coupling with each socket of the coupling improperly sealed; or (ii) two channels of a one socket in the coupling improperly sealed. Accordingly, for a channel having a configuration of 0.015 in. H deep and 0.060 W wide, the 0.0015 in.² area covers one socket in the coupling improperly sealed and the 0.0030 in.² area covers two sockets improperly sealed. It should be understood that the listed cross-sectional areas could cover scenarios of channel configurations not listed.

For each of the five total channel cross-sectional areas, the pressure time dependent function was calculated and plotted for the small residential system in FIG. 5A. The plot shows for each of the five total channel areas the pressure drop over a two minute period in the small residential system. According to the plots, increasing cross-sectional areas results in a greater rate of pressure evacuation from the channels.

A third model was generated to approximate the preferred coupler in a fire protection system for a medium residential occupancy. The third model assumes that the system is constructed using 450 feet of one inch piping, fifty 90-Degree elbows and fifty Tees to define a system volume Vₐ, including the four percent increase, of about 23.192 gal. The initial system air pressure Pₐ^{o} was set to 10 psi and the initial system air temperature Tₐ^{o} was assumed to be 68° F. The pressure profile for each of the five total channel cross-sectional areas is plotted in FIG. 5B.

A fourth model was generated to approximate the preferred coupler in a fire protection system for a large residential occupancy. The fourth model assumes that the system is constructed using about 750 feet of one inch piping, seventy 90-Degree elbows and seventy Tees to define a system volume Vₐ, including the four percent increase, of about 38.584 gal. The initial system air pressure Pₐ^{o} was set to 10 psi and the initial system air temperature Tₐ^{o} was assumed to be 68° F. The pressure profile for each of the five total channel cross-sectional areas is plotted in FIG. 5C.

A fifth model was generated to approximate the preferred coupler in a fire protection system for a commercial occupancy. The fifth model assumes that the system is constructed using about 500 feet of 1½ inch nominal pipe, 750 feet of one inch piping, one hundred 90-Degree elbows and one hundred Tees to define a system volume Vₐ, including the four percent increase, of about 90.168 gal. The initial system air pressure Pₐ^{o} was set to 10 psi and the initial system air temperature Tₐ^{o} was assumed to be 68° F. The pressure profile for each of the five total channel cross-sectional areas is plotted in FIG. 5D.

The plots characterize how readily a modeled preferred coupler with a channel evacuates a piping system under pressure. For each of the channel cross-sectional areas modeled, evacuation of a measurable amount of air pressure occurred within two minutes. Combining the modeled results with the test assembly data, it is believed that a leak path can be created with a coupler having a channel cross-sectional area, measured at the end face, ranging from as small as about 0.0002 square inches (in.²) to about 0.01 in.². However, the plots further indicate that the rate of evacuation decreases with increasing system volume, and it is believed that in order for a preferred coupler to provide an effective leak path to detect an improper seal, the rate of change in pressure in a full system must be dramatic enough to be identified by the piping system operating personnel. Thus where, for example, the operating personnel is monitoring a system pressure gauge in the basement of a medium residential occupancy and the improper seal is in the most remote joint assembly of the piping system, the rate of drop in system pressure due to evacuation from the coupler channel must be significant enough so as to register on the system pressure gauge and be noticeable to the operating personnel.

Thus, for any given channel cross-sectional area, the evacuation pressure profile preferably defines a rate of change in pressure that can be registered on the available pressure sensing or monitoring equipment. A preferred pressure gauge is one that is practical for pneumatic pipe system inspection techniques, such as those described above, and is readily available. The gauge is further preferably graduated to read pressure from 0 psig to 30 psig, so as to be able to register a preferred minimum rate of change in pressure of about 0.5 psig per minute within a piping system. One exemplary pneumatic gauge is manufactured by WIKA Instrumentation Corporation of Lawrenceville, Ga., and graduated from 0-30 psig Referring to the pressure plots of FIGS. 5A-5B, all the channel cross-sectional areas modeled provided the minimum 0.5 psig/min. pressure rate of change for system volumes equal to or smaller than a medium residential occupancy fire protection system. However, the channel configurations defining a total cross-sectional area of 0.0015 in.² or greater provides the preferred initial minimum rate of pressure change of 0.5 psig/min across all the modeled occupancies. Accordingly, an array of channel configurations are available to define an effective leak path capable of evacuating a minimum 10 psi of system air pressure at a minimum rate of 0.5 psig/min in a pneumatic test for a variety of applications. Under the hydraulic pressure testing, the channel configurations preferably provide an initial minimum rate of pressure change of 0.5 psig/2 min across all the modeled occupancies.

However, the ability of the channel to provide an effective leak path is only one factor in defining an appropriate channel configuration for a coupler. As discussed above, it is preferred to maintain a minimum wall thickness in the coupler in order to comply with one or more industry standards. Accordingly, it is believed that in the absence of an outer surface projection 319 on the coupler, as seen for example in FIG. 6C, to maintain a constant wall thickness, a maximum channel depth H is preferably about 0.06 inches. In addition, the channel depth can be configured so as to avoid or minimize the pipe segment ends from abutting the shoulder and closing off the channel from atmosphere. Moreover, by configuring the channel depth H at the preferred maximum or less in a CPVC coupler, the potential for undesirable pooling of cement sealant material within the channel is minimized.

In view of the above factors, for a single channel formed in the coupler, the channel cross-sectional area can range from about 0.0002 in.² to about 0.0036 in.², preferably ranges from about 0.0012 in.² to about 0.0036 in.², and more preferably ranges from 0.0015 in.² to about 0.0036 in.² The channel depth H can range from about 0.005 inches to about 0.060 inches, and the channel width can range from about 0.015 inches to about 0.1 inches. Preferably, the channel depth H ranges from about 0.025 inches to about 0.060 and is most preferably about 0.025 inches, and the channel width W preferably ranges from about 0.025 inches to about 0.060 and is most preferably about 0.060 inches.

While the present invention has been disclosed with reference to certain embodiments, numerous modifications, alterations, and changes to the described embodiments are possible without departing from the sphere and scope of the present invention. Accordingly, it is intended that the present invention not be limited to the described embodiments, but that it has the full scope defined by the language of the following claims, and equivalents thereof.

What is claimed is:

1. A method of checking the integrity of a fire protection piping system having a plurality of joint assemblies, the joint assemblies including at least one coupler having at least one channel, the method comprising:
pressurizing the piping system; and
evaluating whether a leak path between an interior of the piping system and the exterior of the piping system is formed by the at least one channel.

2. The method of claim 1, wherein pressurizing is one of applying positive pressure and applying negative pressure.

3. The method of claim 1, further comprising applying a sealant material to the at least one channel and re-evaluating whether a flow path between an interior of the piping system and the exterior of the piping system is formed by the at least one channel.

4. The method of claim 1, wherein the evaluating includes disposing the at least one coupler about at least one pipe segment and placing the at least one channel in communication with the central passageway of the at least one piping segment.

5. The method of claim 4, wherein placing the at least one channel in communication with the central passageway of the piping segment includes defining the depth, width and length of the at least channel along an inner surface of the coupler.

6. The method of claim 5, wherein defining the depth of the at least one channel such that the depth of the channel varies along its axial length.

7. The method of claim 5, wherein defining the width of the at least one channel such that the width of the channel varies with the depth of the channel.

8. The method of claim 5, wherein defining the length of the at least one channel includes extending the channel from a first end face of the coupler to a second end face of the coupler.

9. The method of claim 4, further comprising forming a shoulder along the inner surface of the coupler to inhibit axial progress of the pipe segment in the coupler, and defining the depth of the channel at its maximum at the shoulder.

10. (canceled)

11. The method of claim 1, wherein the evaluating includes monitoring a loss of pressure in the system.

12. The method of claim 4, wherein the at least one coupler includes a plurality of couplers each having at least one channel, the evaluating including identifying the at least one channel forming the leak path.

13. The method of claim 1 or 4, further comprising deforming the at least one channel so as to form a fluid tight seal between the interior and the exterior of the piping system.

14. A method of leak testing a piping system having at least one joint assembly including a pipe fitting with a pipe segment disposed in the fitting, the method comprising:
defining a leak path between the pipe fitting and the pipe element;
introducing fluid into the system; and
detecting fluid discharge from the channel.

15. A method of detecting a leak in a pipe assembly comprising:
providing at least one fitting attached to a pipe segment to form the assembly, the at least one fitting including a channel to define a leak path; and
flowing fluid through the channel so as to detect leak between the at least one fitting and the pipe segment.

16.-35. (canceled)

36. A method of a joint assembly in a piping system, the method comprising:
disposing a passage proximate a coupling that communicates with an interior passageway of the coupling and an exterior environment proximate to the coupling;
applying a sealant to mating surfaces of the coupling and a pipe;
ceasing the communication provided by the passage so that the interior passageway no longer communicates with the exterior environment of the coupling via the passage.

37. The method of claim 36, the disposing of the passage including disposing the passage through a wall of the coupling.

38. The method of claim 36, the disposing of the passage including disposing the passage in an area between the mating surfaces.

39. The method of claim 36, further comprising, after the disposing of the passage, forming a leak path from the interior passageway to the exterior environment and through the passage.

40. The method of claim 36, wherein disposing the passage includes forming the passage so as to be spiral helically disposed around a longitudinal axis of the coupling.

41. The method of claim 36, wherein the disposing includes disposing the passage parallel to a longitudinal axis of the coupling.

42. The method of claim 36, wherein the disposing includes having the mating surface of the coupling define at least a portion of the passage.

43.-85. (canceled)

86. The method of claim 4, wherein placing the at least one channel in communication includes defining the channel to have a cross-sectional area at an end face of the at least one coupler ranging from about 0.0002 in.² to about 0.1 in.².
